(19) United States
(12) Patent Application Publication
(10) Pub. No.: US 2008/0109342 A1
(43) Pub. Date: May 8, 2008

(54) ELECTRONIC ASSET ASSIGNMENT AND TRACKING

(76) Inventors: JASON WIENER, Indianapolis, IN (US); Joseph Sacerdote, Freehold, NJ (US); Arlene Sacerdote, Freehold, NJ (US)

Correspondence Address: DEAN P. ALDERUCCI, CANTOR FITZGERALD, L.P., 110 EAST 59TH STREET (6TH FLOOR), NEW YORK, NY, 10022, US

(21) Appl. No.: 11/968,914

(22) Filed: Jan. 3, 2008

Related U.S. Application Data
(62) Division of application No. 10/127,226, filed on Apr. 19, 2002.
(60) Provisional application No. 60/284,953, filed on Apr. 19, 2001.

(51) Int. Cl. G06Q 40/00

(52) U.S. Cl. 705/36 R

(57) ABSTRACT

Electronic asset assignment and tracking systems and methods are provided. When assets and attributes are not specified at the time of a trade, a user may assign assets, corresponding quantities, and other attributes post trade. A limit may be set on the time allotted for assigning the assets. When the limit is reached, a default asset (or assets) may be automatically assigned. These default assets (in their entirety or as a supplement to assets previously assigned) may be assigned to allow the trade to be processed. If not enough assets were assigned, the trade may default. Selecting a trade (e.g., from a tab of trades that have not been fully assigned assets) may take the user to a dialog box to view and input asset information. Before or after trades are assigned assets, they may be assigned confirmation numbers. Previously made trades may be viewed in a trade history tab.

### CROSS REFERENCE TO RELATED APPLICATION

This application is a divisional of U.S. patent application Ser. No. 10/127,226, filed Apr. 19, 2002; which claims the benefit of U.S. Provisional Patent Application Ser. No. 60/284,953, filed Apr. 19, 2001, each of which is hereby incorporated by reference herein in its entirety.

### BACKGROUND OF THE INVENTION

The invention relates to systems and methods for assigning and tracking assets and post trade attributes, and in particular, systems and methods for electronically assigning and tracking assets and post trade attributes for trades in markets in which the assets or liabilities delivered in a transaction are unknown at the point of purchase or sale.

In order for a transaction to settle, the unknown assets and liabilities will have to be revealed to the counter parties of the trade. These assets and liabilities may be the securities that make up a transaction (e.g., mortgage pools, receivables, loan trading), collateral to a loan (e.g., a sale and repurchase agreement) or a hedge to another transaction (e.g., a foreign exchange transaction that hedges another purchase or sale, an interest rate swap sale that hedges a bond purchase).

The assets and liabilities of, for example, sale (reverse repurchase) and repurchase agreements are frequently unknown at the point of trade. The assets and liabilities of such agreements are often declared after the time of trade. Another financial transaction in which the assets and liabilities are often declared as part of the post-trade process are mortgage backed securities in which the pools are mortgages that are assigned after a price/rate has been agreed upon. Another example is a security that is being bid on as part of a new debt or equity product. In the bid example, attributes such as the coupon and maturity of the security may be assigned after the bid has been submitted and accepted by the counterparty to the transaction. Still yet another example involves the purchase of liabilities (e.g., account receivables) in which a price is agreed upon for a class of receivables (e.g., good loans, bad loans, distressed corporation issues) but the receivables are assigned as part of the post trade process.

Asset and post trade attribute assignment and tracking will be discussed primarily in connection with sale and repurchase agreements. This is merely exemplary. The invention may be used to assign and track assets and post trade attributes in any suitable market. For example, the invention may be used to assign and track assets and post trade attributes in the sale (reverse repurchase) and repurchase agreements, the mortgage-backed securities market, the procurement of accounts receivables, assets securitized by credit card receivable, trading of assets securitized by recreation vehicle loans or automobile loans, whole loan trading markets, debt and equity issuance markets, assets securitized by leases of equipment, buildings, commercial real-estate, and any other product in which the purchase or sale is a “class” of instrument and not the specific assets/liabilities delivered.

Sale and repurchase agreements are trade agreements in which one party (i.e., the borrower) requests a loan from a second party (i.e., the loaner). The loaner may request collateral in the form of, for example, securities to back the loan. The loaner may request specific securities as the collateral or may request that the securities meet certain criterion. For example, the loaner may specifically request that the collateral be 002YR bonds. As another example, the loaner may generally request that the collateral be over night bonds that mature in less than 10 years.

The parties may agree on the date that the trade becomes effective. The date the trade becomes effective may be the date on which the collateral and money for the loan are exchanged. The parties may also agree on the date that the collateral and money are returned to the respective original parties. When the money is returned to the loaner, the borrower often pays interest to the loaner. The rate at which interest is accrued is generally agreed upon at the time of the agreement.

Typically, the assignment of collateral is handled by settlement desks. Generally, the assignment of collateral may be handled by anyone involved in the trade processing. A significant amount of human assistance in assigning collateral and settling the agreements is required. Such assigning and settling may be burdensome and time consuming. Moreover, it may be difficult for a party assigning collateral to be certain that a certain security meets the criterion set by the loaning party. It may also be difficult for the party assigning collateral to be certain that the party has the quantity of that security that they are assigning available to be assigned as collateral.

It is therefore desirable that the amount of human assistance to assign assets and to select post trade attributes be reduced.

It is also desirable that the time it takes to assign assets and to select post trade attributes be reduced.

It is also desirable that the settlement of transactions that have assets and attributes assigned post trade be largely handled electronically.

It is also desirable to link the transaction created at point of purchase/sale of a security class (agreement) with the actual exchange of assets and liabilities of the transaction for the purposes of record keeping and audits in regards to the transaction agreement.

### SUMMARY OF INVENTION

It is therefore an object of the invention to reduce the amount of human intervention to assign assets and to select post trade attributes.

It is also an object of the invention to reduce the amount of time it takes to assign assets, liabilities, and post trade attributes.

It is also an object of the invention to electronically assign assets, liabilities, and post trade attributes of transactions.

It is also an object of this invention to link the transaction created at point of purchase/sale of a security class (agreement) with the actual exchange of assets and liabilities of the transaction for the purposes of record keeping and audits in regards to the transaction agreement.

In accordance with the invention, systems and methods for electronic asset assignment and tracking are provided. The systems and methods of the invention may allow for less human assistance and full automation of the assignment process. These benefits may translate into lower cost for operating asset and liability assignment and tracking systems.

The invention may also allow for greater price discovery. Those products that previously could not be traded electronically may be traded utilizing the systems and methods of the present invention. Greater price discovery may lead to tighter spreads (i.e., the difference between the price the market is willing to pay or receive) and greater liquidity.

Offers for the exchange of assets may be displayed in response to requests for assets. For example, a prospective borrowing party may request to borrow 25 million dollars. In response to that request, one or more prospective loaners may indicate that they are willing to lend the money in exchange for collateral. The particular type of security to be assigned as collateral may be specified (e.g., 002YR bonds) or it may be specified that the security must meet a specific criteria (e.g., bonds that mature in less than ten years). The prospective loaners may also indicate on which date the collateral and money is to be exchanged. The prospective loaners may also indicate the date on which the collateral is to be repurchased and the money (plus interest) is to be returned. The rate at which interest is accrued is preferably indicated in the offer. These offers may be posted on a user interface for prospective borrowers. The names of the prospective loaners and borrowers may be undisclosed.

A prospective borrower may lift an offer displayed on the user interface. If the offer specified a particular asset to be exchanged as collateral, it may not be necessary to determine what collateral must be assigned. Therefore, the trade based on that offer may be posted on a user interface for the prospective borrower in such a way that it is indicated that the trade has collateral fully assigned.

If an offer without specified collateral were lifted, the trade based on that offer may be posted on a portion of a user interface for trades that do not have collateral fully assigned. The portion may indicate how much time is left to assign collateral for each trade.

A user may select a trade from the portion of a user interface for trades that do not have collateral fully assigned to assign collateral. In response to selecting a trade, a collateral information dialog box (CIDB) may appear. In an alternative embodiment, the CIDB may appear in response to an offer without specified collateral being lifted. In yet another embodiment of the invention, the dialog box may be configured for the electronic assignment of other securities within other asset classes. In addition to assets being used as collateral to a loan, the assets/liabilities may be used for securitizing and as asset/mortgage backed security. In the cases of a dialog box for the assignment of mortgage pools, the dialog box may be called the Pool Information Dialog Box or PIDB. The CIDB may be used to select an asset or assets, and a corresponding quantity or quantities for the selected asset or assets, to be assigned as collateral. The CIDB may list all of the securities that the user may be able to assign as collateral or only those that meet the criteria or criterion set by the loaning party. The CIDB may also list the available quantity of each asset that may be assigned.

In another suitable embodiment, the asset or assets that may be assigned as collateral and the available amount of each of those assets may be displayed in response to the user selecting a field for an asset or a quantity. A user may select one or more assets and enter a quantity for each of the selected assets. The user may indicate that those quantities of selected assets may be entered as collateral by, for example, pressing the “Enter” key on a keyboard. In response to entering the assets and quantities, the information in the CIDB may be updated.

As previously indicated, the CIDB preferably indicates what assets and the quantities of each of those assets that have been assigned as collateral. The CIDB preferably also indicates the price per asset of each asset listed, and the all-in price of each asset listed. The all-in price is the total cash value of the quantity of a particular asset that has been assigned. The all-in price for a particular asset may be determined by calculating the product of the quantity of shares of a particular asset that has been assigned and the price per asset of that particular asset, inclusive of accrued interest of the underlying asset. For example, given a bond with a nominal value of 10,000,000 with a clean trade price (exclusive of accrued interest) of 90.00 (i.e., 0.9), the principal value of the bond is 9,000,000. With an outstanding accrued interest amount of 1,000,000, the total cash value of the bond may be 10,000,000 or an all-in price of 100.00 (i.e., 1.00). The sum of all of the all-in prices of each of the assigned assets may be displayed in the CIDB. The total price of assigned collateral required (as set by the loaning party) may also be displayed.

If the total of the all-in prices is just greater than or meets the requested price, the trade is fully assigned and may be automatically posted to a portion of a user interface for fully assigned trades. If the total all-in price is much greater than the requested price, the user may be provided with an opportunity to edit the assignments such that the assigned collateral does not exceed the requested price by as much.

In another suitable embodiment, the assets may not automatically be posted to the portion for fully assigned trades when the total all-in price is just greater than or meets the requested price. The prospective borrower may indicate when they have finished selecting assets and the corresponding quantities to assign as collateral. The trade may be posted to the portion for fully assigned trades when the user has indicated that they have finished assigning collateral.

A reminder may be displayed in the CIDB and in the portion of a user interface for trades that have not been fully assigned. The reminder may indicate the amount of time left to assign collateral for trades. The reminder may be any suitable graphical or audible reminder. For example, the reminder may be a clock that counts down the amount of time left to assign collateral to a trade. If collateral has not been fully assigned to a trade when the time limit expires, a default asset or assets may automatically be assigned.

For example, if the requested price for a trade was 50 million dollars and the total all-in price of available collateral was 10 million dollars, 40 million dollars worth of a default asset may automatically be assigned as collateral. If 40 million dollars worth of the default asset were not available, the available quantity of that asset may be assigned. A second default asset may be selected to make up the difference in the total value of collateral needed as per the all-in price (including the total available quantity of the first default asset). The appropriate quantity of the second default asset may be chosen such the total value as per the all-in price equals or exceeds the requested price. If the requested quantity of the second default asset is equal to or exceeds the requested quantity, the second default asset is assigned. If the quantity (as per the all-in price) of the second default asset is not available, the total available quantity of the second default asset may be assigned. An appropriate quantity of a third default asset may be selected to make up the difference, and so on until the requested collateral value as per the all-in price is met. If the collateral value cannot be met through the assignment of available assets, the parties to the transaction can choose to default (“break the trade”) or establish the loan for the available amount of collateral.

The assets displayed in the CIDB may be sorted in any suitable manner. For example, the listing of securities may be sorted alphabetically, by the coupon, the CUSIP number (Committee on Uniform Securities Identification Procedures), or the maturity of the security. For other asset classes, the information may be sortable by other attributes descriptive of that asset class. For example, other assets may be sorted by MBS (mortgage backed security) pool numbers, location of loans made as part of securitized assets, settlement date, and debt issuer.

Trades posted to a portion of a user interface for fully assigned trades and the portion of a user interface for those trades that have not been fully assigned may be listed in a portion of a user interface for trade history. The trade history portion may indicate whether a trade has been fully assigned, the status of the trade (e.g., “active,” “pending,” etc.), the requested price of the trade, the all-in price for the trade, a trade reference number for the trade, and a confirmation number of a trade (if any). The trade reference numbers and confirmation numbers (if any) of trades are preferably also displayed in the portion for fully assigned trades and the portion for those trades that have not been fully assigned.

Trade reference numbers may be assigned to those trades based on offers that have been lifted. The trade reference numbers may be used by both the loaning party and the borrowing party to identify trades.

Confirmation numbers may be given to trades to confirm that a trade has occurred. The confirmation number is preferably distinct from the trade reference number. Confirmation numbers may be given to trades when they are lifted or when they become fully assigned. When an offer with collateral that is specified is lifted, the trade based on the offer preferably automatically posts to the portion of a user interface for fully assigned trades with a confirmation number. For those trades based on offers that do not have collateral specified, a confirmation number may be assigned when the offer is lifted or when the trade posts to the portion for fully assigned trades.

When a fully assigned trade is selected (e.g., from the portion for fully assigned trades or from the portion for trade history) the CIDB may be displayed. The CIDB may display information regarding the securities and corresponding quantities assigned as collateral. Such information may be read-only. In such circumstances, any suitable way of displaying the information or any suitable indicator to indicate that the information is read-only may be used. For example, gray over-tones may be displayed over fully assigned trades displayed in the CIDB.

The systems and methods of the present invention may be used to electronically assign and track any suitable asset. For example, the present invention may be used to assign and track mortgage-backed pass-through certificates. As an illustration, those mortgage-backed pass-through certificates issued by GNMA (Government National Mortgage Association), FHLMC (Federal Home Loan Mortgage Corporation), and FNMA (Federal National Mortgage Association) may be used to help those agencies finance mortgage loans made by banks and other financial institutions. Similar mortgages are grouped in “pools” and then similar pools of mortgages are delivered to satisfy the sale or purchase of a mortgage-backed pass-though certificate. At the point of trade when the buyer and seller agree on price, the mortgage pools that will be delivered are unknown. Between the time of the trade and before the settlement (start) date of the transaction, the actual mortgage pools to be delivered have to be communicated by the seller to the buyer. The invention preferably allows for the mortgage pools to be communicated electronically as an extension to the original transaction. This will automate a currently manual process and improve the audit trail by directly connecting the asset delivery to the trade.

As stated previously, the invention may be used to assign receivables to an asset that is part of a post trade process. Such an asset may be an asset that is being bid on as part of a new debt or equity product. For example, new issued Corporate debt and Government debt and equity are all products in which the market participants send bids on an asset (prices at which they are willing to purchase) in anticipation of issuance of the asset. At the time of bid submission, not all of the asset attributes are known. Attributes such as settlement price and coupon maturity date may be decided at issuance. The invention allows for these attributes to be communicated as part of the acceptance of the bid at issuance.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a block diagram of hardware that may be used to implement various embodiments of the present invention;

FIG. 2 illustrates offers in response to requests;

FIG. 3 illustrates a prompt confirming that a user desired to lift a particular offer;

FIG. 4 illustrates a tab showing trades that have been FIG. 5 illustrates a tab showing trades that have not been fully assigned;

FIG. 6 illustrates a reminder to assign collateral;

FIG. 7 illustrates a collateral information dialog box;

FIG. 8 illustrates a list of asset information that may be displayed in response to a pull down menu of the CIDB being selected;

FIG. 9 illustrates a CIDB being updated with information for an asset in response to that asset being assigned as collateral;

FIG. 10 illustrates a CIDB being updated with quantity and all-in price information for an asset in response to a quantity of that asset being assigned as collateral;

FIG. 11 illustrates that a trade that was fully assigned collateral is removed from the tab showing trades that have not been fully assigned collateral;

FIG. 12 illustrates that a trade that was fully assigned collateral is moved to the tab showing trades that have been fully assigned;

FIG. 13 illustrates a trade history tab;

FIG. 14 illustrates assigning default assets as collateral;

FIGS. 15 and 16 illustrate formulating requests for assets;

FIG. 17 illustrates a respond to request tab;

FIG. 18 illustrates a dialog box that may be displayed when responding to a request;

FIG. 19 illustrates a menu of tabs;

FIG. 20 illustrates a flow chart of steps involved in determining whether a lifted offer is specific and responding to the determination;

FIGS. 21-24 illustrate a flow chart of steps involved in assigning assets to a trade; and

FIGS. 25 and 26 illustrate a flow chart of steps involved in automatically assigning assets and assigning default assets when the time limit to assign assets for a trade has expired.

### DETAILED DESCRIPTION

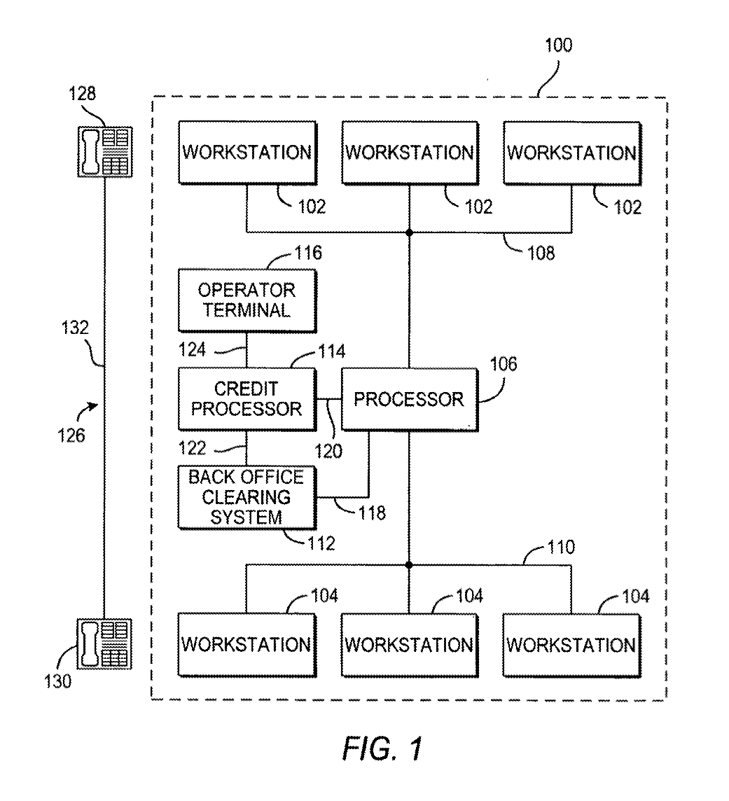

FIG. 1 illustrates an example of hardware 100 that may be used to implement one embodiment of the present invention. As illustrated, hardware 100 may include one or more local workstations 102 and one or more remote workstations 104 that may be used by counter parties to view trading data and enter trading commands. Workstations 102 and 104 may be any suitable means for presenting data and, in preferred embodiments of this invention, accepting input. For example, workstations 102 and 104 may be personal computers, laptop computers, mainframe computers, dumb terminals, data displays, Internet browsers, Personal Digital Assistants (PDAs), two-way pagers, wireless terminals, portable telephones, etc., or any combination of the same.

To orchestrate trading between counter parties using workstations 102 and 104, the workstations preferably submit commands to, and receive data to be displayed from, a processor 106. In alternative embodiments, however, workstations may communicate with additional processors, or include processors to orchestrate trading in a distributed fashion without requiring processor 106. In yet other embodiments, processor 106 may be connected to an external trading system (not shown) that controls trading by the counter parties. Processor 106, and any additional processors, may be any suitable circuitry or devices capable of processing data such as microprocessors, personal computers, network servers, mainframe computers, dedicated computer systems, etc.

As shown, processor 106 may be connected to workstations 102 and 104 by networks 108 and 110, respectively. Each of networks 108 and 110 may be any suitable data network for communicating data between processor 106 and workstations 102 and 104, such as a local area network, a wide area network, the Internet, an intranet, a wireless network, a hard wired connection, a dial-up network, etc., or any combination of the same. In an arrangement of hardware 100 without processor 106, workstations 102 and 104 may be linked together by networks 108 and 110 directly.

Workstations 102 and 104, processor 106, and networks 108 and 110 may collectively form a trading system.

As also shown in FIG. 1, a telephone network 126 may be provided that comprises a local telephone 128 and a remote telephone 130 connected by a telephone line 132. Telephone network 126 may be used to enable a counterparty at a remote location to communicate with another counterparty at a workstation 102 or 104. This may be useful when the counterparty does not have access to a workstation 102 or 104 or when the counterparty only has access to a display-only workstation 102 or 104. Obviously, telephone network 126 may be implemented as a private telephone network, a public telephone network, a wireless telephone network, or any suitable combination of the same.

When used to assign and track assets and post trade attributes, the trading system as described above may enable a prospective borrower to input a request for a loan, may enable a prospective loaner to input a response to the request (e.g., an offer), and may enable the prospective borrower to lift an offer. As an illustration, a prospective borrower at, for example, workstation 102 may input a request for a loan. The request may be processed by processor 106. Processor 106 may then display the request to prospective loaners at, for example, workstations 104. The prospective loaners may then input responses to the requests. Processor 106 may process these responses and display them as offers to the prospective borrower at workstation 102.

A back office clearing system 112 and a credit processor 114 may also be connected to processor 106 of the trading system via communication links 118 and 120, respectively. Clearing system 112 may be any suitable equipment, such as a computer, for causing trades to be cleared and/or verifying that trades are cleared. Credit processor 114 may be any suitable equipment, such as a computer, for monitoring and controlling transactions as described hereinbelow. Credit processor 114 may be controlled by one or more operator terminals 116 via communication link 124, and/or by workstations 102 and 104 via networks 108 and 110 and processor 106. Operator terminals 116 may be any suitable circuitry or devices capable of providing a control interface for credit processor 114 such as microprocessors, personal computers, network servers, mainframe computers, dedicated computer systems, dumb terminals, computer monitor and keyboard, etc. Clearing system 112 may communicate with credit processor 114 via communication link 122, and communication links 118, 120, 122, and 124 may be any suitable data network for communicating data, such as a local area network, a wide area network, the Internet, an intranet, a wireless network, a hard wired connection, a dial-up network, etc., or any combination of the same.

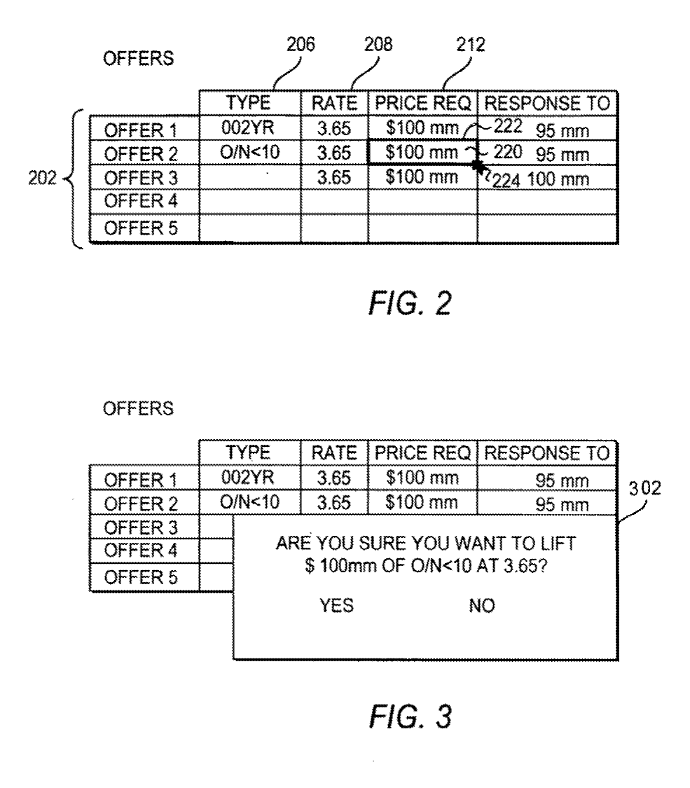

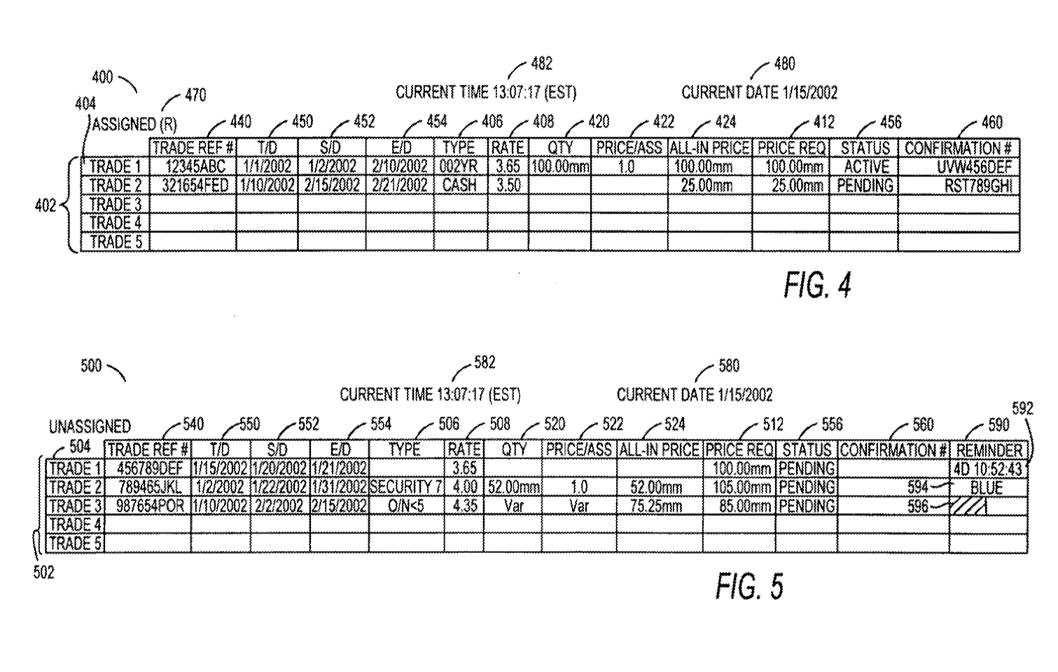

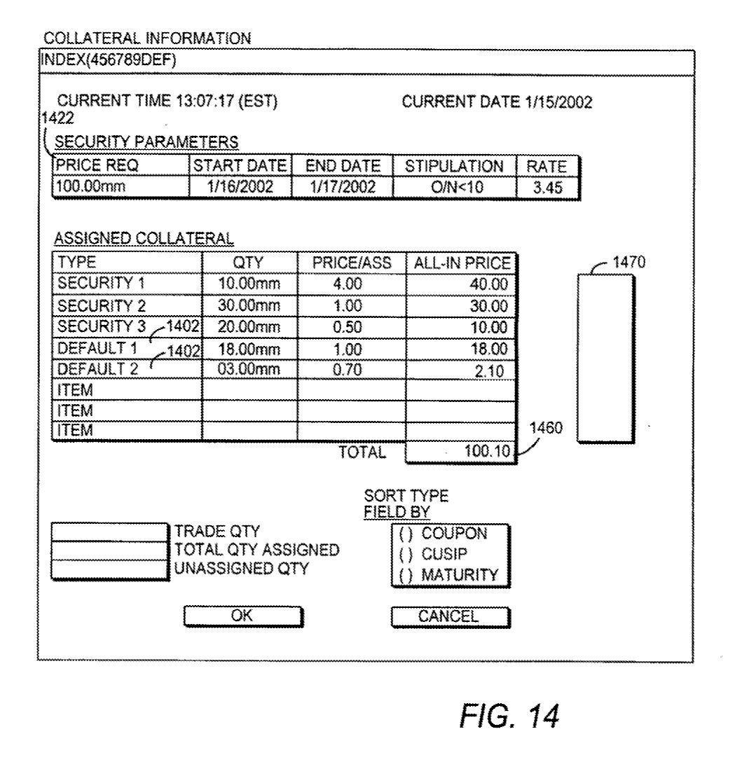

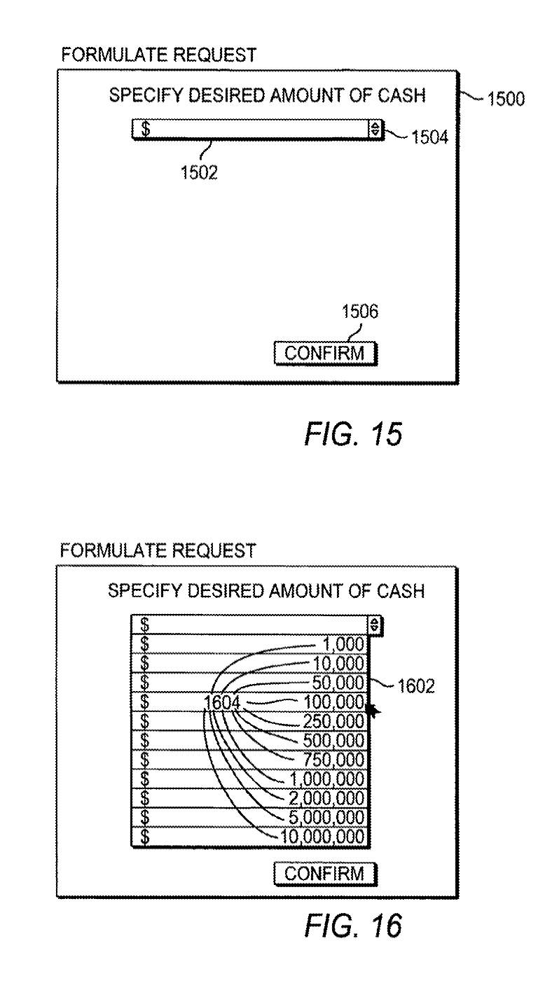

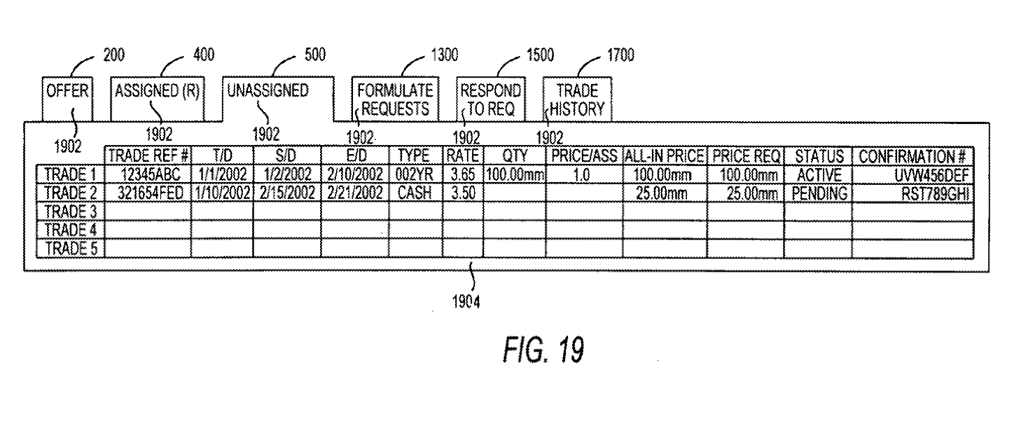

FIG. 2 illustrates an offer tab 200. Tabs such as offer tab 200 may be displayed on, for example, a workstation (e.g., workstation 102) of a prospective borrower. Tabs such as offer tab 200, fully assigned tab 400 of FIG. 4, unassigned tab 500 of FIG. 5, formulate requests tab 1300 of FIG. 13, respond to requests tab 1500 of FIG. 15, and trade history tab 1700 of FIG. 17 may be displayed on, for example, workstation 102 simultaneously or as part of a menu. For example, these tabs may be part of menu 1900. Menu 1900 will be described in more detail below in connection with FIG. 19.

Offer tab 200 indicates that there are general and special offers that may be lifted. Information displayed in offer tab 200 may include a type indicator 206, a rate indicator 208, and a price requested indicator 212 for each offer 202 and any other suitable offer information. Generally, type indicator 206 indicates whether a specific kind of asset was requested as collateral, whether an asset that meets a criteria was requested (e.g., an asset that matures in less than ten years, an asset that meets a certain rating), or whether the request was a general request for collateral. If a specified collateral was requested, it is preferably indicated.

For example, for the offer labeled “Offer 1,” the collateral was specified. In this case, the type is 002YR. For the offer labeled “Offer 2,” the collateral was not specified. Here, the collateral requested was for an overnight transaction for assets (e.g., bonds) that mature in less than 10 years. For “Offer 3,” no collateral was specified and no criteria was specified. These examples are merely illustrative. Any suitable type for an offer 202 may be indicated by type indicator 206. The rate for each offer is indicated by rate indicator 208. The price requested for each offer is indicated by price requested indicator 212. As shown, the rate and price requested for each offer 202 are the same at 3.65 and $100 million, respectively. This is merely illustrative. Any suitable rate or price requested for each offer 202 may be indicated by rate indicator 208 and price requested indicator 212, respectively.

In the embodiment shown in FIG. 2, a user may choose to lift an offer 202 by, for example, double-clicking (e.g., with a pointing device such as a cursor) on any portion of the row associated with that offer 202. A user may also lift an offer by using a keyboard (e.g., at workstations 102 or 104) to select any portion of an offer and hitting the “return” or “enter” key on the keyboard or by any other suitable method.

An offer 202 or any portion of an offer 202 may be highlighted to indicate that offer 202 may be selected. As shown in FIG. 2, portion 220 of the offer 202 labeled “Offer 2” is highlighted. Highlight ring 222 may have been positioned around portion 220 in response to keyboard keystrokes or a pointing device (e.g., at workstations 102 or 104) such as cursor 224 being over portion 220.

In response to lifting an offer 202, a dialog box may appear on-screen prompting the user to confirm that the selected offer 202 was the offer the user wanted to select. For example, as shown in FIG. 3, dialog box 302 appears as an overlay prompting the user to accept the terms of the offer 202 lifted. If, for example, the user attempted to lift the offer 202 labeled “Offer 2,” information such as the type, rate, and price requested of “Offer 2” may be displayed as part of the prompt. As shown, dialog box 302 prompts the user to accept 100 million dollars worth of overnight assets that mature in less than ten years at a rate of 3.65 in response to the user attempting to lift “Offer 2.”

If an offer without specified collateral was lifted (e.g., “Offer 2”), a dialog box separate from dialog box 302 may indicate to the user that the user must specify collateral for the trade and that if collateral is not specified for the trade, a default asset (or assets) may be selected as the collateral. The user may have to confirm acknowledgment of these terms. Such a prompt is not shown.

In some embodiments, when an offer is lifted, the transaction is automatically assigned a trade reference number. Both parties receive this reference number. The trade reference number is a unique identification number or code for each transaction that may be used for identifying the transaction (e.g., which offer was lifted), for verification purposes, or both. Both parties can easily refer to the transaction by referring to the trade reference number.

When an offer is lifted, it may be posted to either fully assigned tab 400 (FIG. 4) or unassigned tab 500 (FIG. 5). Transactions based on offers with specified collateral may be automatically posted to fully assigned tab 400. When a transaction posts to fully assigned tab 400, the transaction may be assigned a confirmation number. The confirmation number is a confirmation code preferably distinct from the trade reference number associated with the transaction. The confirmation number appears after assignment of collateral for a transaction is acknowledged by the bid/buy side. For an offer in which the collateral was specified (e.g., a specified repo), the collateral is known and the transaction is preferably automatically acknowledged by the bid/buy side. Therefore, for specified transactions, the transaction is preferably automatically given a confirmation number. The confirmation number may be given prior to, simultaneously to, or after the transaction is posted to fully assigned tab 400.

Assigned assets may be directed by a counterparty to a settlement system for trade clearance. For US Treasuries, the assets may be directed to, for example, the Government Securities Clearing Corporation for exchange of assets (e.g., securities and cash). For assets which can be directed to one of multiple clearing services, the counterparties to the transaction may agree on a specific clearing service. The assets may automatically be directed to the chosen service for processing.

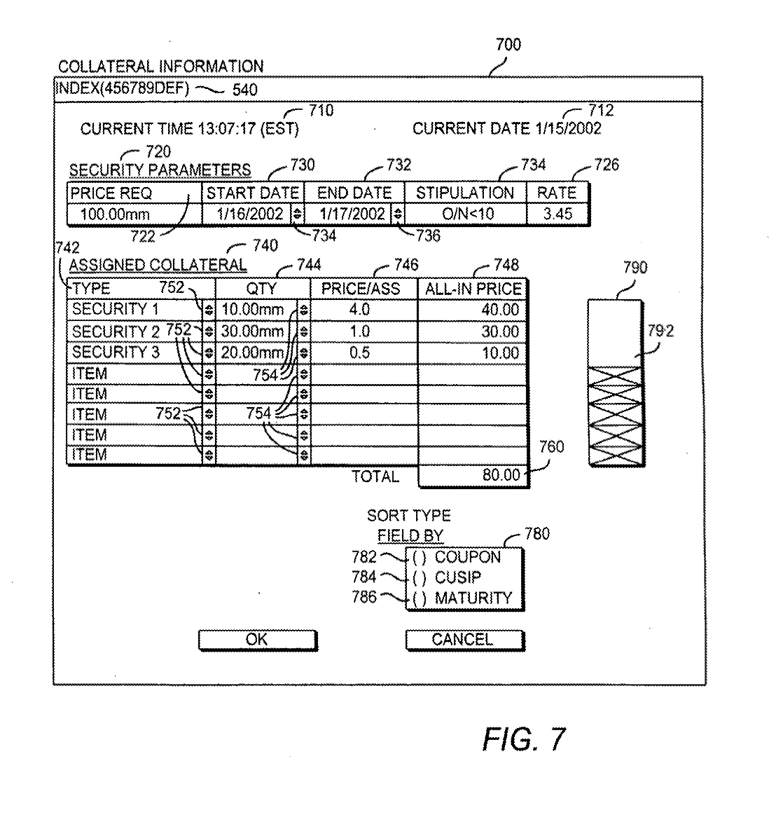

For those offers without specified collateral, the transaction may be automatically posted to unassigned tab 500 of FIG. 5 and the transaction may be given a confirmation number. In the alternative, collateral information dialog box 700 of FIG. 7 may be displayed in response to an offer without specified collateral being lifted. Collateral information dialog box 700 allows a user on the bid/buy side to specify the collateral for a transaction. Once the collateral is assigned, the transaction may be posted to fully assigned tab 400 and the transaction may be given a confirmation number. Collateral information dialog box 700 will be described in more detail below in connection with FIGS. 7-10.

When an offer is lifted, the transaction may be recorded in trade history tab 1300 of FIG. 13. Trade history tab 1300 may show some or all of the pertinent information related to a transaction. Such information may include the trade date, start date, end date, type, quantity, and trade reference number of a transaction. Trade history tab 1300 may also show the confirmation number (if any) of a transaction. If a transaction has been posted to fully assigned tab 400 (FIG. 4) and has a confirmation number, the confirmation number preferably is displayed in trade history tab 1300. If a transaction has not been posted to fully assigned tab 400 (FIG. 4) or otherwise does not have a confirmation number, the confirmation number for that transaction may read “Pending.” The confirmation number for a transaction displayed in fully assigned tab 400 (FIG. 4) and unassigned tab 500 (FIG. 5) are preferably the same as those confirmation numbers displayed in trade history tab 1300. Trade history tab 1300 will be described in more detail below.

Returning to FIG. 4, several offers with specified collateral have previously been lifted. These offers have been posted to fully assigned tab 400. Trades 402 posted to tab 400 have been fully assigned and are preferably read-only. That is, once a transaction has been completed, a user preferably cannot edit the information (e.g., change the assignment information) for a transaction. As shown, trade date indicator 450 indicates that trades 402 are read-only. Gray over-tones (not shown) may also be displayed over fully assigned tab 400 to indicate that trades 402 are read-only. Gray over-tones may be displayed in addition to indicator 450 or without indicator 450.

The information shown for trades 402 is preferably based on the information for offers 202 shown in tab 200 (FIG. 2). For example, the information shown for offer 202 (FIG. 2) labeled “Offer 1” is the same as the information shown for trade 402 labeled “Trade 1” (i.e., trade 404). As shown, the type, rate, and price requested of trade 404 (indicated by type indicator 406, rate indicator 408, and price requested indicator 412) are the same as the type, rate, and price requested for “Offer 1” (FIG. 2). Unless otherwise specified, those numbers, dates, types, etc. that are indicated by an indicator (e.g., a rate indicated by rate indicator 408) may herein be referred to by the reference numeral of that number, date, type, etc. (e.g., rate 408).

Also associated with each trade is a trade reference number 440, a trade date 450, a settlement (start) date 452, an end date 454, a status indicator 456, and a confirmation number 460. As stated previously, trade reference numbers such as numbers 440 are unique identification numbers or codes for each trade. Numbers 440 may be used for identifying the trade, for verification purposes, or both. Both parties can easily refer to a particular transaction by referring to a trade reference number 440.

Trade dates 450 indicate what days individual trades 402 took place. Settlement dates 454 indicate what days individual trades 402 become effective and the day that collateral must be fully assigned (if necessary) and exchanged. End dates 454 indicate what days individual trades 402 end. Status indicator 456 indicates whether a trade 402 is either pending (i.e., has a forward start date) or active (i.e., has a forward end date). For a particular trade 402, if settlement date 452 is the next business day (including holidays) after trade date 450 or later, the status of that trade 402 is “pending.” If settlement date 452 is the same as the current date or earlier and end date 454 is the next business day (including holidays) or later, the status of that trade 402 is “active.”

For example, for trade 404, the settlement date 452 and end date 454 are Jan. 2, 2002 and Feb. 10, 2002, respectively. As shown by current date indicator 480, the current date is Jan. 15, 2002. Because the settlement date is before the current date and the current date is before the end date, the trade is “active.” The “active” status of trade 404 is indicated in status indicator 456. Current time indicator 482 may display the current time. As another example, if the trade date were Jan. 1, 2002, the current date were Jan. 15, 2002, and the settlement date were Jan. 20, 2002, the trade would be “pending.”

As indicated by type 406, quantity 420, and price per asset 422, ten thousand shares of 002YR valued at 10 dollars per share were assigned as collateral for trade 404. As indicated by price requested indicator 412, the total all-in price of the asset or assets assigned as collateral requested to complete trade 404 was 100 million dollars. According to offers 202, the borrower must return the money borrowed plus interest. The rate at which the interest is accrued is indicated by rate indicator 408. For trade 404, rate 408 is 3.65. Thus, if 100 million dollars were borrowed for 40 days (e.g., difference in time between the end date and start date; Feb. 11, 2002 and Jan. 2, 2002) at a rate of 3.65, 100 million dollars plus 405,555.56 dollars in interest would be returned on the end date.

All-in price 424 may indicate the product of the quantity of assets and the price per asset. That is, all-in price 424 may be the product of quantity 420 and price per asset 422. All-in price 424 may be useful in that it indicates the total dollar value of all of the collateral assigned to a particular trade. This may be useful when, for example, an offer for a repurchase agreement (e.g., in response to a request to borrow cash) indicates the total requested dollar value of the collateral to be assigned. As indicated by price requested 412, for example, the total price of collateral requested for trade 404 was 100 million dollars.

Confirmation numbers 460 are the confirmation codes assigned to each individual trade 404.

As stated previously, those trades that do not have collateral fully assigned may have confirmation numbers. Alternatively, trades may not receive a confirmation number until the collateral for that trade is fully assigned. As shown in fully assigned tab 400, all of trades 402 have confirmation numbers 460. As shown in unassigned tab 500 of FIG. 5, none of the trades have confirmation numbers. This is merely exemplary.

Turning to FIG. 5, unassigned tab 500 will be described in more detail. As shown in FIG. 5, each trade 502 preferably has a trade reference number 540, a trade date 550, a settlement (start) date 552, an end date 554, a type 506, a rate 508, a quantity 520, a price per asset 522, a all-in price 524, a price requested 512, a status 556, and (depending on the embodiment) a confirmation number 560. In those embodiments in which trades will not be assigned confirmation numbers unless they are fully assigned, confirmation number 560 may be unnecessary. Unassigned tab 500 may also display a current date indicator 580 and a current time indicator 582.

Trade reference number 540, trade date 550, settlement date 552, end date 554, type 506, rate 508, quantity 520, price per asset 522, all-in price 524, price requested 512, status 556, and confirmation number 560 preferably operate in the same manner as trade reference number 440, trade date 450, settlement date 452, end date 454, type 406, rate 408, quantity 420, price per asset 422, all-in price 424, price requested 412, status 456, and confirmation number 460 of FIG. 4.

As stated previously, trades 502 do not have collateral fully assigned. Trades 502 may have no assets assigned as collateral or trades 502 may be partially assigned collateral. That is, an asset or assets may be assigned as collateral for a trade 502. The total all-in price (i.e., product of quantities of assets and price per assets) of the asset or assets assigned to a trade 502 preferably do not exceed the price requested 512 of that trade 502. If the total all-in price of a trade 502 exceeds the requested price, the trade 502 is preferably automatically posted to fully assigned tab 400 (FIG. 4). Alternatively, user entry of a trade that has an all-in price that exceeds the requested price may be required before the trade is posted to fully assigned tab 400 (FIG. 4).

As shown, types 506 may indicate the type or types of assets (if any) assigned as partial collateral. For trade 502 labeled “Trade 2,” type 506 is “Security 7.” For this trade, only one asset has been assigned as collateral. For the trade labeled “Trade 3,” several assets may have been assigned as collateral. Here, type 506 specifies a criterion for the assets assigned as partial collateral. A criterion may also be specified for a single asset instead of the name of the individual asset assigned.

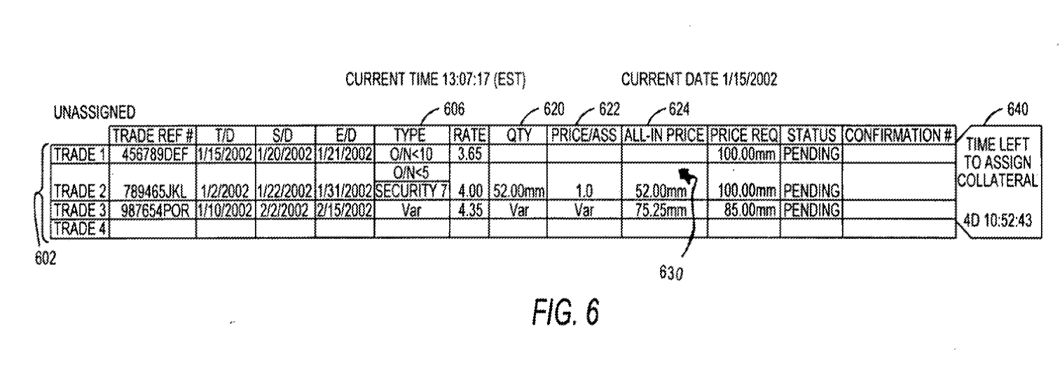

In alternative embodiments for trades that have not been fully assigned, such as those shown in FIG. 6, types 606 for trades 602 may display more information. For example, for trade 602 labeled “Trade 2,” the criterion (i.e., O/N<5) and the name of the individual asset (i.e., “Security 7”) assigned as collateral may both be listed under type 606. As another example, for trade 602 labeled “Trade 2,” all of the assigned assets making up the partial assignment of collateral may be listed under type 606. Type 606 may also indicate that more than one asset makes up the partial assignment. As shown for trade 602 labeled “Trade 3,” this is indicated by the abbreviation “VAR” for varied.

These examples are merely illustrative. Any type indicator (e.g., type 406, type 506, type 606, etc.) may list any suitable information regarding the type or types of asset or assets (if any) assigned as collateral (partial or full). Such type indicators may list any other suitable information such as a criterion or criteria or that more than one asset has been assigned as collateral.

Quantity indicators such as quantity indicators 520 and 620 of FIGS. 5 and 6 may also indicate the quantity or quantities of an asset or assets assigned as collateral, whether different quantities of different assets have been assigned, and that no quantity of any asset has been assigned. For the trade 602 labeled “Trade 2” for example, the quantity of “Security 7” assigned as collateral is 52 million shares. Quantity 620 also indicates that, generally, “Trade 3” has assets with different quantities assigned as collateral. This is indicated by the abbreviation “VAR.”

FIGS. 5 and 6 also show that price per asset indicators 522 and 622 may indicate the price per asset of each asset assigned as collateral, that the price per share of the assets assigned for one trade are different (e.g., indicated by “VAR”), or both.

All-in price indicators 524 and 624, shown in FIGS. 5 and 6, show that the all-in price for each asset assigned as collateral may be displayed. If more than one asset was assigned as collateral for an individual trade, the all-in price for each asset, the total all-in price for all of the assets, or both, may be displayed.

For example, the total all-in price for the trade 602 labeled “Trade 2” is listed as 52 million dollars. Only one asset was assigned as collateral for “Trade 2” and only one all-in price is listed. For each of the three securities assigned as collateral for the trade 202 labeled “Trade 3,” an all-in price is listed. The total all-in price (i.e., the sum of the all-in prices for all of the individual assets) is also listed. As shown, the all-in price for “Security 8,” “Security 9,” and “Security 10” are 24, 12, and 16 million dollars, respectively. The total all-in price is 52 million dollars.

These examples are merely illustrative. Any quantity indicator (e.g., quantity 420, quantity 520, quantity 620, etc.) may list any suitable information regarding the quantity or quantities (if any) of an asset or assets assigned as collateral (partial or full). Any price per asset indicator (e.g., price per asset 420, price per asset 520, price per asset 620, etc.) may list any suitable information regarding the price per asset of any asset or assets (if any) assigned as collateral. A price-in indicator (e.g., price-in 420, price-in 520, price-in 620, etc.) may list any suitable information regarding the price-in of any asset or assets (if any) assigned as collateral.

How assets that were not specified as part of an offer get assigned as collateral will be described in connection with collateral information dialog box (CIDB) 700 of FIG. 7. How different quantities of assets get assigned and how these quantities of assets get posted to, for example, a fully assigned tab will also be described in connection with FIG. 7. Also described in connection with FIG. 7 will be how a trade that does not have collateral fully assigned gets updated.

As shown in FIG. 5, trade 504 has no asset or assets assigned as collateral. Because no asset or assets were assigned as collateral, no all-in price 524 has been listed for trade 504. To indicate that no asset has been assigned to a trade and that there is no all-in price information, all-in price may list “N/A” for “not available.” Any other suitable indication that there is no all-in price information may be sufficient.

As also shown in FIG. 5, for those trades 502 that have collateral assigned, the all-in price 524 of the asset or assets may be listed. In these embodiments, the all-in price preferably does not meet or exceed the price requested 512 for that trade.

As shown, all-in price 524 for trade 502 labeled “Trade 2,” 52 million dollars, is less than the 100 million dollars requested for that trade. When an all-in price that is less than the price requested is listed for a trade, it may be indicated that the all-in price is less than the requested price. To indicate that an all-in price is less than the requested price, the all-in price may be highlighted, shaded (e.g., gray over-tones), or a different color than the requested price or other portions of the information displayed for that trade. These examples are merely exemplary. Any suitable way to indicate that an all-in price is less than the requested price is sufficient. For example, all-in price 524 for a trade 502 may be in bold or in a different font than the other portions of that trade 502. Although all-in prices for trades may be less than the requested prices, reminders that collateral must still be assigned for those trades preferably function in the same manner.

As shown in FIG. 5, a reminder 590 may be associated with each trade 502. Each reminder 590 may indicate the time left to assign collateral to a trade that has not been fully assigned. Reminder 590 may be any suitable reminder to remind the user of the amount of time, generally or specifically, left to fully assign collateral to a trade. For example, reminder 592 is a clock that counts down the time to assign collateral. Reminder 594 may be a color coded scheme of how much time remains. If, for example, 40 plus minutes remain, reminder 594 may be blue; 20 to 40 minutes remain, reminder 594 may be yellow; 10 to 20, orange; 0 to 10, red. Another suitable reminder may be reminder 596. Reminder 596 is a horizontal shrinking bar. A shrinking vertical bar may also be used. Preferably, only one type of reminder (e.g., reminder 592, 594, or 596) is displayed on screen at one time. Reminders 592, 594, and 596 are displayed simultaneously in connection with unassigned tab 500 for convenience.

Any combination of these reminders may be used. For example, shrinking bar reminders (e.g., reminder 596) may use the color scheme described in connection with reminder 594. As another example, the count down timer of reminder 592 may be overlaid on top of reminder 594. These examples of reminders are merely illustrative. Any suitable reminder to remind a user of how much time is left to assign collateral to a trade may be used. For example, an audible reminder (e.g., a series of beeps that progressively gets faster as the time limit approaches) may be used alone or in combination with a graphical reminder.

In another suitable embodiment, a reminder may be displayed when a cursor is positioned over a portion of a trade or a portion of a trade is highlighted. As shown in FIG. 6, cursor 630 is positioned over a portion of information associated with trade 606. In response to cursor 630 being positioned over information associated with trade 606, a reminder 640 may be displayed. Reminder 640 indicates how much time is left (e.g., graphically, audibly) to assign collateral to trade 606. Reminder 640 may be displayed automatically after cursor 630 is positioned over information related to a trade or after a delay (e.g., 3 seconds). These examples are merely illustrative. Reminder 640 may be displayed in response to any suitable event. For example, reminder 640 may be displayed in response to the user clicking on a portion of a trade 604 using cursor 630.

Collateral information dialog box (CIDB) 700 is illustrated in FIG. 7. CIDB 700 illustrates the assignment of collateral for the trade 502 (FIG. 5) with trade reference number 540 “456789DEF” (i.e., trade 502 (FIG. 5) labeled “Trade 1”). As stated previously, a user may assign collateral to a trade that has not been fully assigned collateral (e.g., trades 502 (FIG. 5)) by selecting that trade. In an alternative embodiment, CIDB 700 may be displayed in response to a user lifting an offer without specified collateral. In those embodiments in which CIDB 700 is displayed in response to a user lifting an offer, a trade reference number is preferably automatically assigned to the trade. In response to a user selecting the trade 502 (FIG. 5) with trade reference number 540 “456789DEF” from tab 500 (FIG. 5) or in response to lifting an offer 202 (FIG. 2) from offer tab 200 (FIG. 2), CIDB 700 may be displayed.

As shown in CIDB 700, the trade reference number of the trade for which collateral is being assigned is preferably displayed at the top of CIDB 700. The trade reference number may be displayed anywhere in CIDB 700. Alternatively, the trade reference number may not be displayed. In those embodiments in which the trade reference number is not displayed, it is preferable that the user will be able to easily determine the number. For example, CIDB 700 and tab 500 (FIG. 5) may be displayed simultaneously. CIDB 700 may also be displayed over tab 500 (FIG. 5) as an overlay. In both cases, the trade reference number or any other portion or portions of the trade for which collateral is being assigned may be, for example, highlighted or displayed in bold.

The current date and time may be indicated in CIDB 700 by date and time indicators 710 and 712, respectively.

Parameters for the transaction may be displayed by asset parameters box 720. Included in parameters box 720 may be price requested 722, stipulation 724, and rate 726. Price requested 722, stipulation 724, and rate 726 are preferably based on an offer (e.g., an offer from offers 202 (FIG. 2)) that was lifted. Because this information is based on a lifted offer, the user assigning collateral in exchange for the assets may be bound to these limitations. That is, the user may not be able to change price requested 722, stipulation 724, and rate 726. As such, it may be indicated that this information is read-only. For example, gray over tones may be displayed over this information.

Price requested 722 may be the total requested price of assets to be assigned as collateral in order for a trade to be processed. As previously indicated, price requested 722 may be the price requested from the loaner (e.g., loaner of cash, securities, etc.). Stipulation 724 may also be set by the loaner. Stipulation 724 may indicate a criterion or criteria that the asset or assets to be assigned as collateral must meet. In FIG. 7, for example, stipulation 724 indicates that the assets or asset that can be assigned must be overnight securities that mature in less than 10 years. Rate 726 may indicate the rate (e.g., interest rate) of the repurchase agreement.

Settlement (start) date 730 may indicate the date on which the collateral and the assets pledged in exchange for the collateral must be exchanged. End date 732 may indicate the date on which the collateral must be repurchased and the assets (plus interest—preferably accrued at rate 726) loaned in exchange for the collateral must be returned. Start date 730 and end date 732 may be fixed (e.g., read-only) or they may be edited.

When start date 730 or end date 732 may be edited (e.g., when they are not set by the prospective loaner), a user may enter the fields for start date 730 or end date 732 by, for example, double-clicking on the respective field. A user may then enter the numbers (digits or letter representation; e.g., “10” or “ten,” “3” or “March,” etc.) corresponding to the month, day, and year of the desired start date 730 and end date 732. A user may also edit start date 730 and end date 732 by selecting pull down menus 734 and 736, respectively. Upon selecting pull down menu 734 or 736, a list of selectable dates or a calendar with selectable dates may appear. If a user selects a date for start date 730 or end date 732 from pull down menus 734 or 736, that date is preferably displayed in the field for start date 730 or end date 732, respectively.

As shown in assigned collateral box 740, the fields associated with (e.g., in the same column as) type 742 and quantity 744 have pull down menus 752 and 754. In response to selecting pull down menu 752, a list of available assets that may be assigned as collateral and that meet stipulation 724 may be displayed.

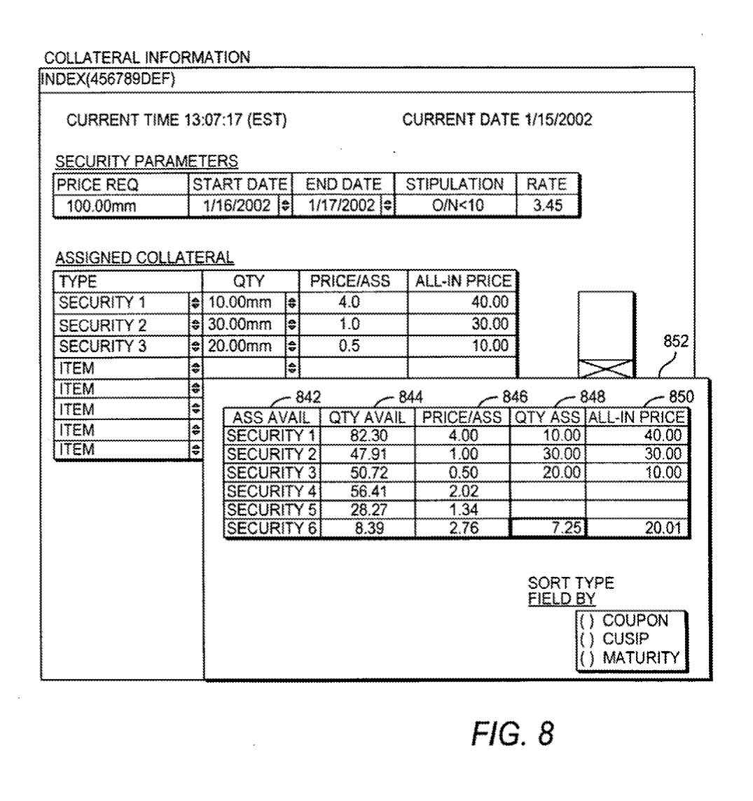

As shown in FIG. 8, list 852 displaying available assets that may be assigned as collateral and that meet stipulation 724 (FIG. 7) may be displayed in response to selecting pull down menu 752 (FIG. 7). List 852 may also display the available quantity 844, price per available asset 846, quantity assigned 848 (if any), and all-in price 850 for each asset available 842. List 852 may also be displayed in response to pull down menu 754 being selected or double-clicking on any portion of CIDB 700. List 852 may be displayed as an overlay over CIDB 700. If list 852 is displayed as an overlay over CIDB 700, list 852 is preferably not displayed over any portion of assigned collateral box 740 that has information regarding an asset assigned as collateral. List 852 and CIDB 700 may be displayed simultaneously as separate menus. In another suitable embodiment, the information displayed in list 852 may be displayed in CIDB 700.

In another suitable embodiment, a list of only available assets may be assigned as collateral and that meet stipulation 724 may be displayed in response to pull down menu 752 being selected. Similarly, if an asset 742 (e.g., asset 742 labeled “Security 1”) were assigned as collateral, the quantity of that asset 742 available to be assigned may be displayed in response to pull down menu 754 being selected. If a quantity were entered into a field 744 for an asset 742 and pull down menu 754 were selected, the quantity entered and the total quantity available to be assigned as collateral may be displayed simultaneously.

Assets 742 may be selected by, for example, highlighting an asset 742 from a list of assets (e.g., a list displayed in response to pull down menu 742 being selected) and hitting the “Enter” key on a keyboard or double-clicking or the asset 742 with a pointing device. Quantities 744 may be selected by, for example, entering a quantity field and entering the number for the desired quantity.

Alternatively, an asset 742 or quantity 744 or both may be selected from list 852 (FIG. 8). An asset 742 may be selected by highlighting a listing for an asset 842 (FIG. 8) from list 852 (FIG. 8) and hitting the “Enter” key or double-clicking or that asset 842 (FIG. 8). A quantity 744 for that asset from list 852 (FIG. 8) may then be selected in the same manner described above. In another embodiment, a quantity 744 may automatically be entered in response to, for example, a user entering a quantity for an asset in a quantity assigned field 848 (FIG. 8) and hitting the “Enter” key.

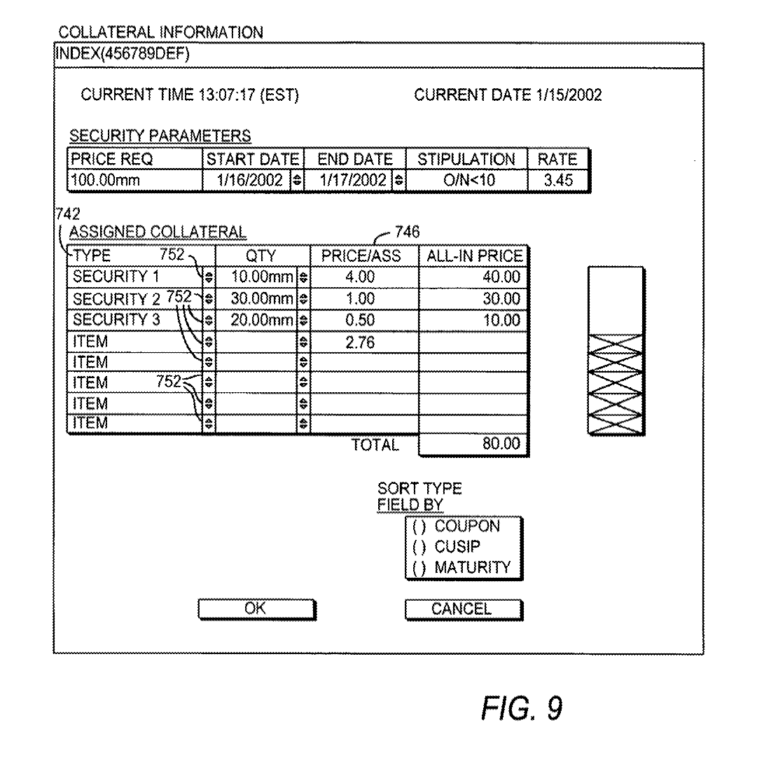

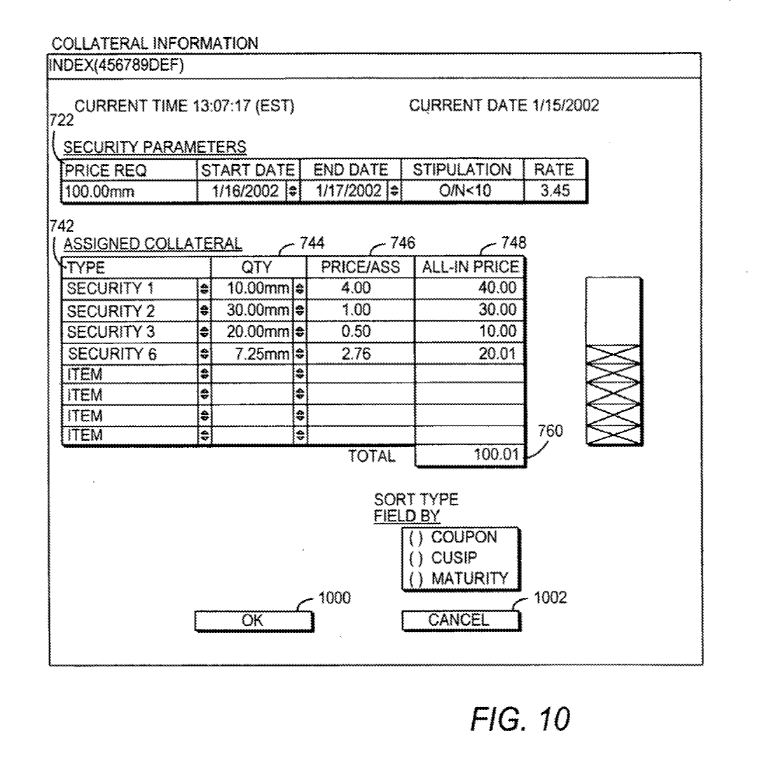

Price per asset 746 is preferably automatically displayed in response to an asset 742 being selected. All-in price 748 is preferably automatically displayed in response to (or simultaneously to) both quantity 744 and price per asset 746 being selected and displayed, respectively. As shown in FIG. 9, for example, asset 742 labeled “Security 6” was chosen from pull down menu 752 (FIG. 7) or selected from list 852 (FIG. 8). In response to “Security 6” being selected, price per asset 746 for asset 742 labeled “Security 6” is automatically displayed. FIG. 10, illustrates that when both a quantity 744 and an asset 742 are entered, the all-in price 748 for that asset 742 may automatically be displayed. Here, 7.25 million shares were entered as quantity 744 of “Security 6,” and 20.01 million dollars was automatically displayed as all-in price 748. As shown, total all-in price 760 is preferably updated accordingly.

Assets 742 and quantities 744 for assets 742 may be selected in any suitable way. The examples provided are merely illustrative. Assets 742 and quantities 744 may be selected in ways other than those described in connection with list 852 (FIG. 8) and pull down menus 752 and 759. For example, a name of an asset 742 and a numeral for a quantity 744 may be entered into the corresponding fields for asset 742 and quantity 744.

Assets 742 may be sorted in any suitable way. For example, assets 742 may be sorted alphabetically, by the coupon, the CUSIP number, or the maturity of the asset 742. As shown in FIG. 7-10, assets 742 may be sorted by the coupon, the CUSIP number, or the maturity of the asset 742 in response to selecting coupon option 782, CUSIP option 784, or maturity option 786, respectively, from “Sort Type Field By” box 780.

As indicated previously, all-in price 748 for assets 742 is preferably displayed in response to an asset 742 and a corresponding quantity 744 being entered. Total all-in price 760 indicates the sum of the all-in prices 748 of assets 742. Total all-in price 760 may be useful in that it may be an easy reference of the total of the all-in prices of all assets 742 assigned as collateral. Total all-in price 760 may be quickly compared to price requested 722 to determine the total value of collateral that still needs to be assigned (if any).

As illustrated in FIG. 7, a reminder 790 may be displayed in CIDB 700. Reminder 790 may indicate how much time is left to fully assign collateral to a trade. Reminder 790 is a shrinking vertical bar. In this embodiment, when the bar 792 is depleted, the time to fully assign collateral to a trade has expired. When the time to fully assign collateral has expired, default collateral may be assigned to a trade. Default collateral will be described below in connection with FIG. 14.

Although FIG. 7 illustrates several assets 742 already assigned as collateral, when CIDB 700 is initially displayed for a particular trade 502, it is preferable that no information is displayed in type 742, quantity 744, price per asset 746, and all-in price 748. In another embodiment, all of the available assets 742 that may be assigned as collateral may be displayed. It is preferable that quantity 744 for assets 742 still needs to be entered.

Turning to FIG. 9, an illustration of an asset 742 being entered and displayed in CIDB 700 is shown. The asset 742 labeled “Security 6” may have been selected from, for example, pull down menu 752. In response to an asset being selected, the price per asset for that asset is preferably automatically displayed. As shown in FIG. 9 for example, price per asset 746 for “Security 6” may automatically be displayed in response to “Security 6” being selected.

As illustrated in FIG. 10, if the price per asset for an asset were known and a quantity for an asset were entered, the all-in price for that asset may automatically be displayed. Here, price per asset 746 for the trade 742 labeled “Security 6” is known. When quantity 744 for “Security 6” is entered, all-in price 748 is preferably automatically displayed.

As shown in FIG. 10, the total all-in price 760 is greater than price requested 722. Assets 742 and corresponding quantities 744 may, therefore, automatically be assigned as collateral for the particular trade. The user may be automatically prompted to enter the assets and quantities as collateral. The user may choose to assign the selected assets as collateral by, for example, selecting “Ok” button 1000. Alternatively, the user may choose not to assign the selected assets by, for example, selecting “Cancel” button 1002. In another suitable embodiment, the user may select “Ok” button 1000 when they are ready to assign the selected assets as collateral (i.e., without being prompted).

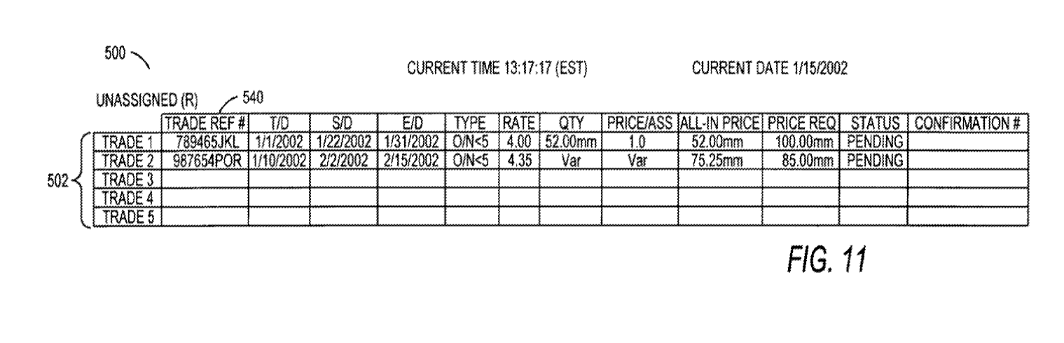

As shown in FIG. 11, trade 502 (FIG. 5) with trade reference number 540 (FIG. 5) “456789DEF” is no longer unassigned. Trade “456789DEF” is no longer posted to unassigned tab 500 (FIG. 5). Any remaining trades that do not have collateral fully assigned may still be posted to unassigned tab 500 (FIG. 5). FIG. 11 illustrates that trade “456789DEF” is no longer posted to unassigned tab 500 (FIG. 5) and that those trades that do not have collateral fully assigned may still be posted to unassigned tab 500 (FIG. 5). As illustrated in FIG. 11, those trades that still do not have collateral fully assigned may have moved up in unassigned tab 500 (FIG. 5) when a trade has been removed from unassigned tab 500 (FIG. 5).

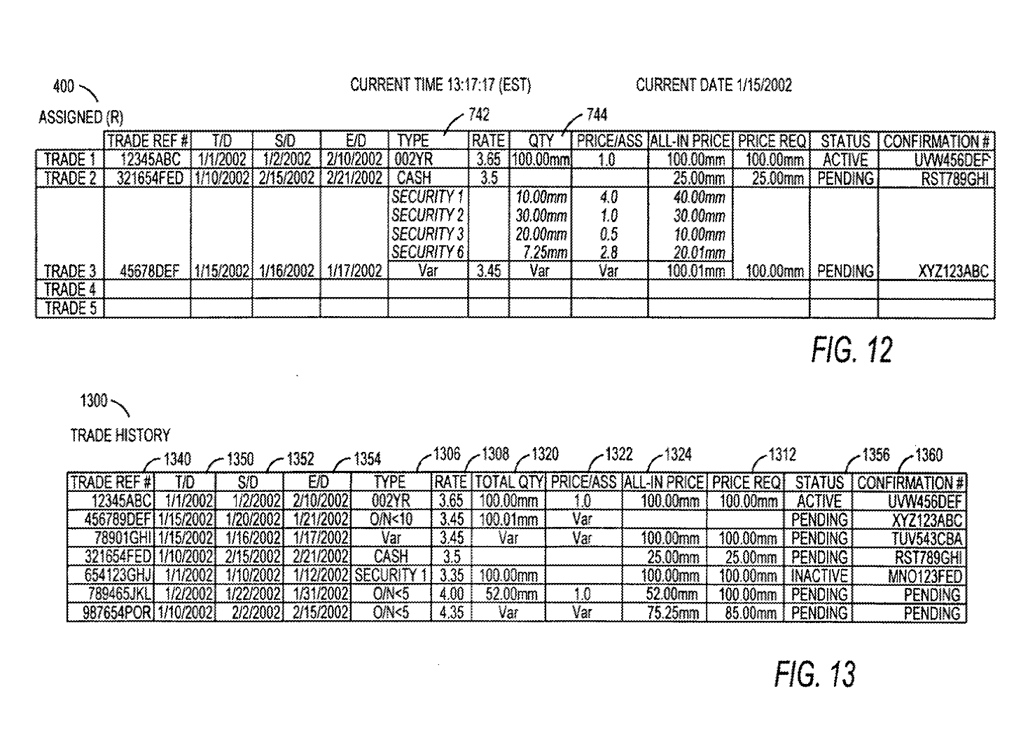

As illustrated in FIG. 12, trade “456789DEF” has been posted to fully assigned tab 400. As shown, all of the assets and corresponding quantities assigned as collateral are displayed under type 742 and quantity 744, respectively. Type 742 and quantity 744 also indicate that more than one asset and more than one corresponding quantity were selected for the assets assigned as collateral. This is indicated by the abbreviation “VAR.”

FIG. 13 illustrates a trade history tab 1300. Tab 1300 may display all of the trades that have taken place. The trades displayed may include fully assigned trades, trades that are not fully assigned, pending trades, active trades or any other suitable trades. For example, tab 1300 may display inactive trades. Inactive trades may be those trades that have already occurred. That is, those trades that have an end date that is in the past.

Tab 1300 may display the trade reference number 1340, the trade date 1350, the settlement (start) date 1352, the end date 1354, the status 1356, the confirmation number 1360, the type 1306, the rate 1308, the quantity 1320, the price per asset 1322, the all-in price 1324, and the price requested 1312 for each trade.

Discussed in connection with FIG. 14 is assigning default assets. When the time limit to assign assets as collateral for a trade has expired, a default asset or assets may be automatically assigned to complete the trade. In the example shown in FIG. 7, the total all-in price is 80 million dollars (indicated by total all-in price 760). The 80 million dollars is short of the 100 million dollars indicated by price requested 722. That is, if the time limit to assign assets expired (indicated by reminder 790), at least 20 million dollars worth of assets would still need to be assigned to meet price requested 722.

When the time limit expires, a default asset may automatically be selected. A quantity of the default asset may automatically be assigned. This quantity is preferably large enough such that the total all-in price is met. If not enough of this default asset is available to meet the price requested, the total available quantity of this default asset is preferably selected. A second default asset may automatically be selected to cover the difference between the price requested and the total all-in price (including the default asset previously assigned). If not enough of the second default asset is available to cover the difference, all of the available quantity of the second default asset may be assigned and a suitable amount of a third default asset may be assigned to cover the difference and so on until the requested price is met.

As shown in FIG. 14, reminder 1490 indicates that the time to assign assets has expired. Price requested 1422 is 100 million dollars. Before default assets were assigned, the total all-in price 1460 was 80 million dollars. A first default asset 1402 labeled “Default 1” was automatically assigned to cover the difference. However, the price per asset of “Default 1” is 1 dollar per share and only 18 million shares of “Default 1” were available to be assigned. At that point, the total all-in price was 98 million dollars. This was still short of price requested 1422 by 2 million dollars. A second default asset 1402 labeled “Default 2” was therefore also automatically assigned. As shown, the price per share of “Default 2” is 0.7 dollars per share. As illustrated, there were at least 3 million shares of “Default 2” available to be assigned. Including the 3 million shares of “Default 2,” the total all-in price 1460 is 100.1 million dollars. This is in excess of price requested 1422 and the trade may be processed.

Default assets 1402 may be pre-determined by the user. The number of default assets 1402 to assign (e.g., two in the example above) may also be pre-determined by the user.

Turning to FIGS. 15 and 16, the formulation of requests to borrow assets is shown. In the illustrations shown in FIGS. 15 and 16, the request is to borrow cash. This is merely exemplary. The request may be for any suitable asset such as a particular quantity of a stock.

Request tab 1500 indicates that a user may specify a desired amount of cash to borrow. The user may manually enter a number into field 1502 or select a number from pull down menu 1504. In response to selecting pull down menu 1504, a list 1602 of default numbers 1604 may be displayed as shown in FIG. 16. A user may select a number 1604 from list 1602 using, for example, a pointing device such as a cursor. In response to a user selecting a number 1604, that number 1604 may be displayed in field 1502 of FIG. 15. Any number or listing (e.g., a listing for an asset) in field 1502 may be edited. If, for example, $100,000 was selected from list 1602 (FIG. 16), the user may change the $100,000 to $102,000 by, for example, entering field 1502 and using a keyboard to manually edit the entry. The user may confirm that the number or listing displayed in field 1502 is the number or listing the user would like to request by, for example, selecting confirm button 1506.

A separate tab (not shown) may indicate those requests that a user has formulated. A user may view requests that he or she has formulated. A user may also be able to rescind requests that he or she has formulated.

A user may respond to requests formulated by other users by selecting respond to request tab 1700 (FIG. 17). As shown in FIG. 17, previously formulated requests 1702 are displayed. Requests 1702 displayed in FIG. 17, are requests for cash. This is merely exemplary. Requests 1702 may be for any suitable asset such as a particular quantity of a stock.

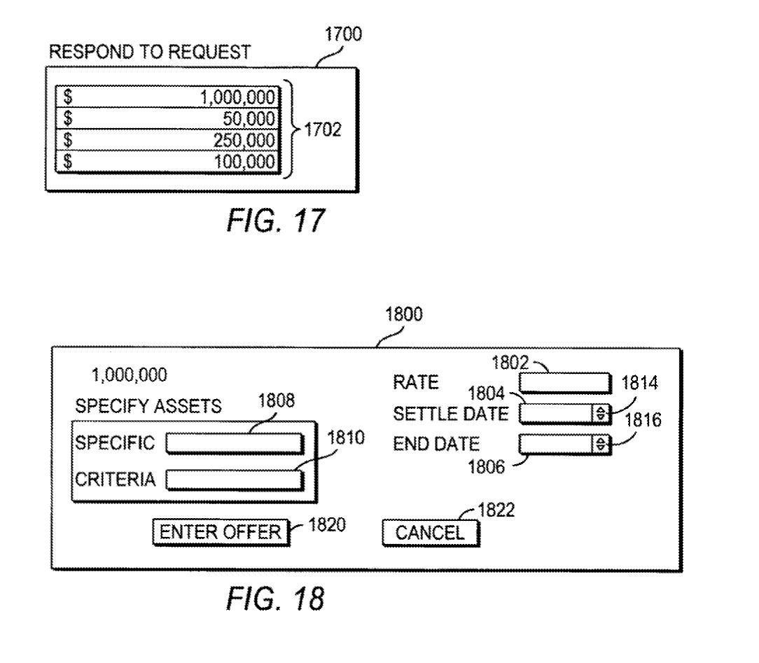

A user may respond to a request 1702 by, for example, selecting the request 1702 to which he or she would like to respond. In response to selecting a request 1702, dialog box 1800 (FIG. 18) may be displayed. The request 1702 to which the user is responding is preferably displayed in dialog box 1800. If, for example, a user were responding to a request 1702 (FIG. 17) for $1,000,000, that request would preferably be displayed in dialog box 1800.

As shown in dialog box 1800, a user responding to a request 1702 (FIG. 17) may specify assets, a rate 1802, a settlement (start) date 1804, and an end date 1806. Rate 1802 may be entered manually (e.g., entered using a keyboard). Dates 1804 and 1806 may be entered manually or selected from a list of dates from pull down menus 1814 and 1816 respectively. A user responding to a request 1702 may specify the assets to be exchanged (e.g., as collateral) for the requested asset (e.g., the asset requested in request 1702 (FIG. 17)). A user responding to a request 1702 (FIG. 17) may specify that a specific asset or assets be exchanged. A responding user may enter a specific asset in specific asset field 1808 for this purpose. Alternatively, a responding user may specify that the asset or assets to be exchanged meet a criteria or criterion. The criterion or criteria may be entered into criteria field 1810 for this purpose.

Once a responding user is satisfied with the entries in fields 1802, 1804, 1806, and fields 1808 and 1810 (if desired), the user may submit the response to the request (i.e., the offer) by selecting, for example, enter offer key 1820. The offer may then be posted to the requesting user's offer tab (e.g., offer tab 200 (FIG. 2)). If a responding user no longer wishes to respond to a request (i.e., no longer wishes to submit an offer), the user may select cancel key 1822. Fields 1802, 1804, 1806, 1808, and 1810 may be cleared and respond to request tab 1700 (FIG. 17) may be displayed.

A separate tab (not shown) may indicate those offers that a user submitted. A user may view offers that he or she has submitted. A user may also be able to rescind an offer that he or she has submitted. A user is preferably not able to rescind an offer after it has been lifted.

FIG. 19 illustrates a menu 1900 of tabs for offers, fully assigned trades, trades that have not been fully assigned, trade history, a tab to formulate a request, and a tab to respond to a request. The information corresponding to a each tab may be displayed by, for example, selecting headings 1902 of each tab. As illustrated in FIG. 19, information 1904 corresponding to trades that have not been fully assigned is displayed. As shown, when information 1904 corresponding to a heading 1902 is displayed, the portions of menu 1900 displaying a heading 1902 and corresponding information 1904 are preferably not disconnected. As shown, information 1904 for trades that have not been fully assigned and heading 1902 for trades that have not been fully assigned are not disconnected.

A user may change the information 1904 that is displayed by, for example, selecting another heading 1902. For example, if a user desired that trade history tab 1300 were displayed, the user may select heading 1902 for “Trade History.” A user may select a tab by, for example, using a cursor or appropriate keyboard strokes (e.g., hitting the control and tab keys simultaneously in Windows®).

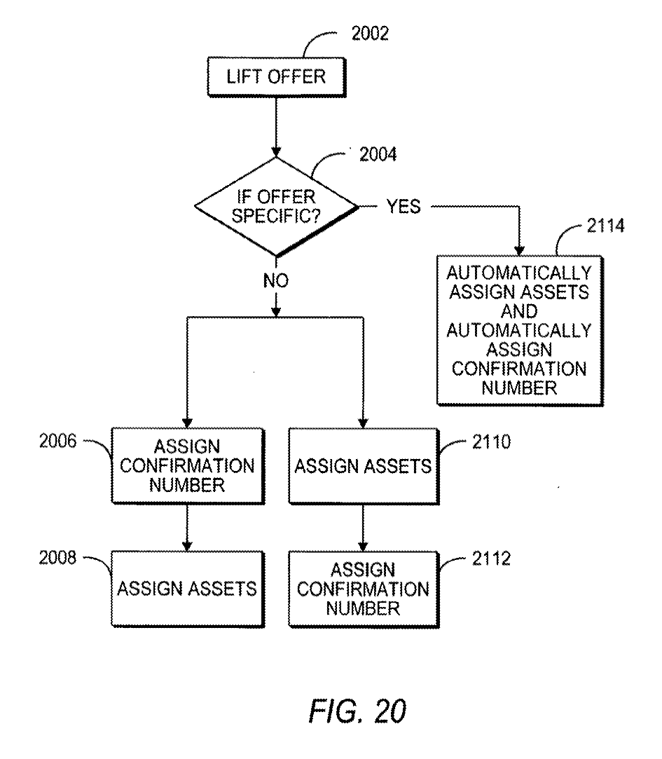

Turning to FIG. 20, a flow chart of illustrative steps that may be involved in determining whether a lifted offer is specific and responding to the determination is shown. At step 2002, an offer is lifted. At step 2004, it may be determined whether the offer requests that specific assets be assigned. If the offer does not request specific assets, a confirmation number may be given to the transaction based on the offer and then assets may be assigned (steps 2006 and 2008) or assets may be assigned and then a confirmation number may be given to the transaction (steps 2010 and 2012). If it was determined at step 2004 that the offer does request specific assets, a confirmation number may automatically be given to the transaction and the assets may automatically be assigned. This may occur at step 2014.

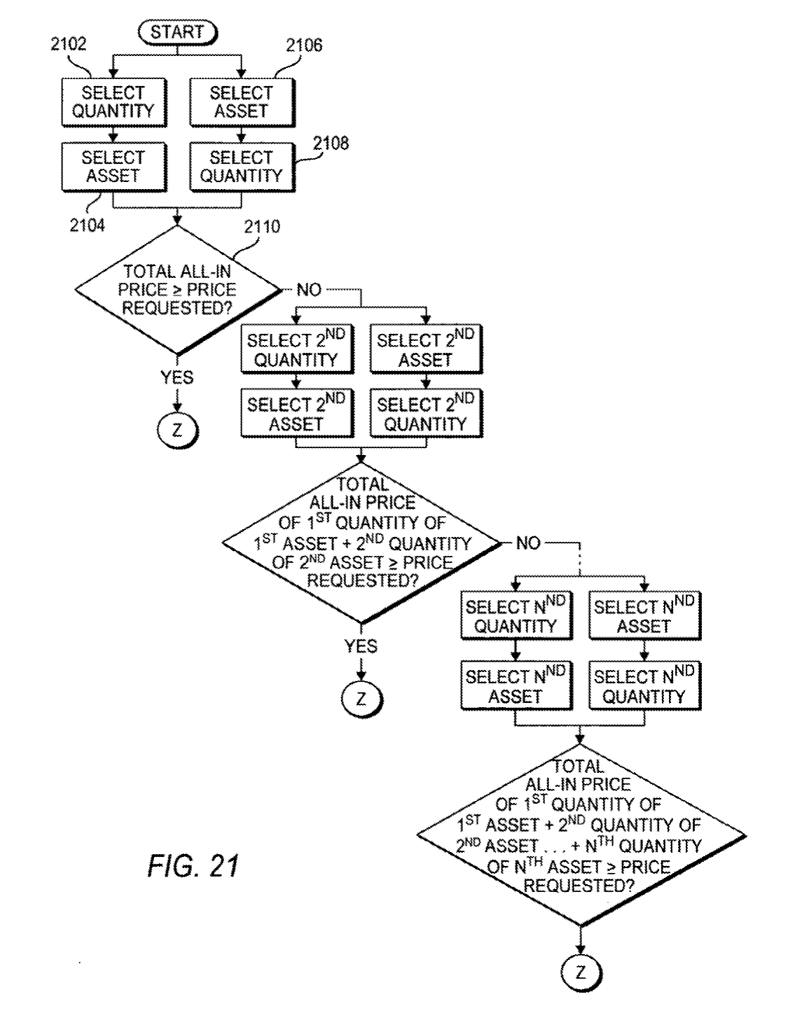

FIGS. 21-24 illustrates a flow chart of illustrative steps that may be involved in assigning assets to a trade. In the embodiment described in connection with FIGS. 21-24, the user may be automatically prompted for an action and the system may automatically change the quantity or quantities of an asset or assets assigned as collateral.

The user may select a quantity for an asset and then select a corresponding asset (steps 2102 and 2104) or the user may select an asset and then select a corresponding quantity (steps 2106 and 2108). At step 2110, the system may determine whether the all-in price (e.g., the product of the price per share of the selected asset and the quantity of that asset selected) is greater than or equal to the price requested.

If the all-in price is not greater than or equal to the price requested, a second asset and second corresponding quantity may be selected (steps 2112, 2114, 2116, and 2118). Once a second asset and a corresponding second quantity have been selected, the system may determine whether the total all-in price is greater than or equal to the price requested. If the total all-in price is not greater than or equal to the price requested, an additional asset or assets and a corresponding quantity or quantities may be selected.

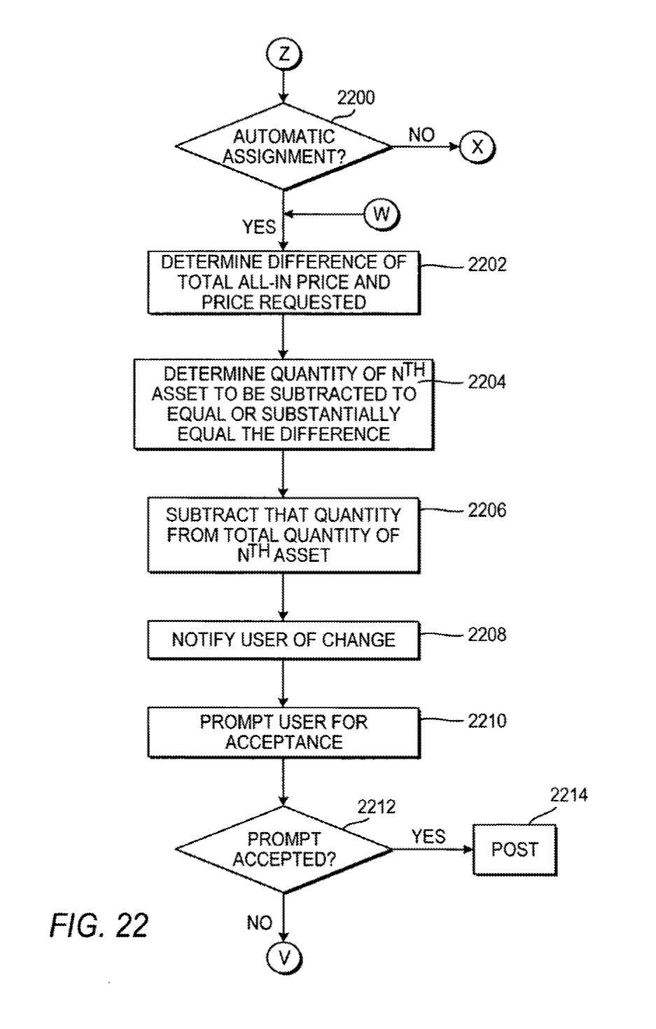

If the total all-in price is greater than or equal to the price requested, the flow may continue to exit point Z. As shown in FIG. 22, the flow may continue from entry point Z to exit point X or the flow may continue to step 2202 based on the determination made at step 2200. The determination made at step 2200 may be whether assets are to be automatically assigned. If the determination made at step 2200 is no, the flow may continue to exit point X. If the determination at step 2200 is yes, the flow may continue to step 2202.

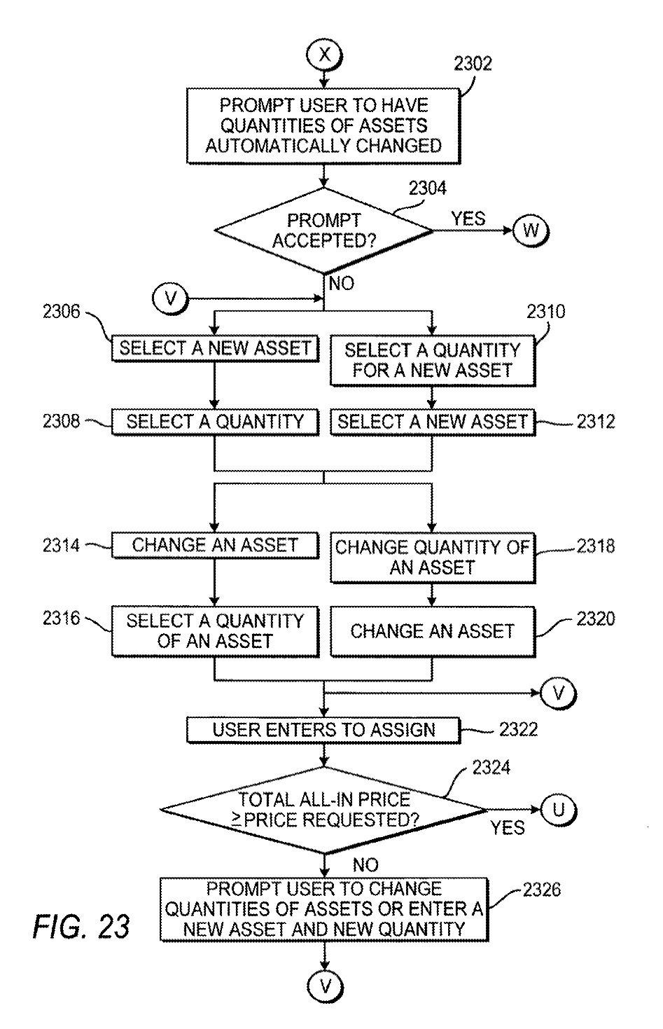

At step 2202, the difference between the total all-in price and the price requested may be determined. At step 2204, the quantity of the last asset selected to equal or substantially equal the difference determined in step 2202 may be determined. That quantity may be subtracted from the total quantity of the last asset selected (step 2206). The user may be notified of the change (step 2208) and prompted for acceptance (step 2210). At step 2212, it may be determined if the prompt was accepted. If the prompt was accepted, the trade may be posted to the fully assigned tab (step 2214). If the prompt were not accepted, the flow may continue at exit point V (FIG. 23).

Exit/entry points X and V will be described in connection with FIG. 23. At entry point X, the flow continues to step 2302. At step 2302, the user may be prompted to have the quantities of assets automatically changed. At step 2304, it may be determined if the prompt was accepted. If the prompt was accepted, the flow may continue to exit point W. At entry point W (FIG. 22), the flow continues to step 2202 (FIG. 22). If, at step 2304, the prompt was not accepted, the user may select a new asset and a new corresponding quantity (steps 2306, 2308, 2310, and 2312). Note that the selected quantity may be zero. The user may change an asset already assigned as collateral and change the quantity of an asset already assigned as collateral (steps 2314-2320). From here, the flow may continue to exit point V or to step 2322.

At step 2322, the user may choose to assign the asset or assets and corresponding quantity or quantities as collateral. At step 2324, it may be determined whether the total all-in price is greater than or equal to the price requested. If the total all-in price is not greater than or equal to the price requested, the user may be prompted to change the quantities of assets assigned as collateral or enter a new asset and a corresponding new quantity as collateral. This may occur at step 2326. From step 2326, the flow may continue to exit point V. If the total all-in price is greater than or equal to the price requested (step 2324), the flow may continue at exit point U.

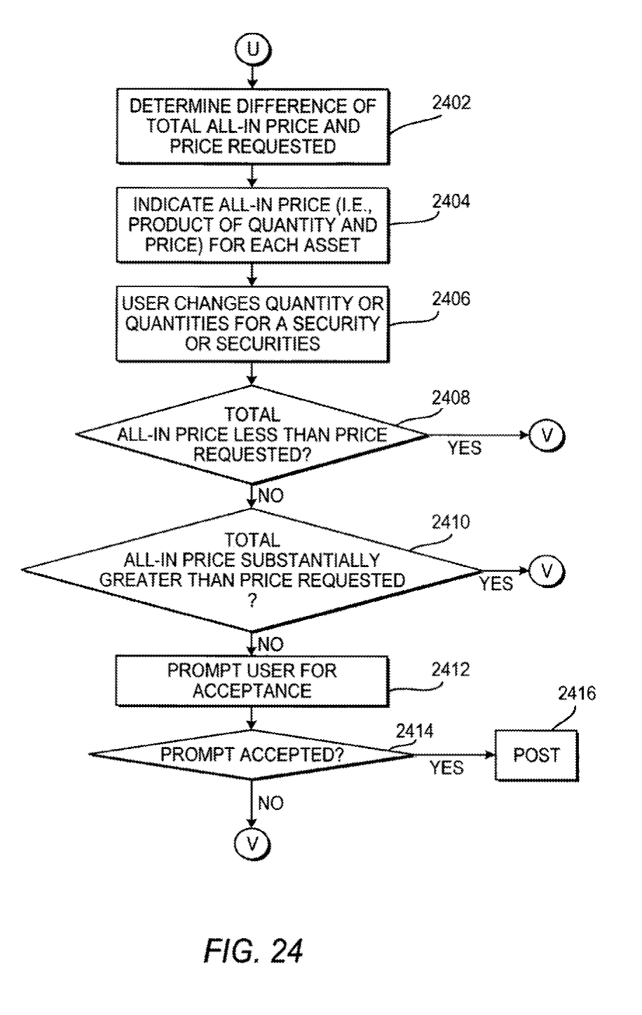

From entry point U, the flow may continue to step 2402 (FIG. 24). At step 2402, the difference between the total all-in price and the price requested may be determined. At step 2404, the all-in price of each asset may be indicated. The user may change the quantity or quantities for an asset or assets at step 2406. At step 2408, it may be determined if the total all-in price is less than the price requested. If the total all-in price is less than the price requested, the flow may continue to exit point V (FIG. 23). If not, the flow may continue to step 2410. At step 2410, it may be determined if the total all-in price is substantially greater than the price requested. If the total all-in price is substantially greater than the price requested, the flow may continue to exit point V. If not, the flow may continue to step 2412. At step 2412, the user may be prompted for acceptance. At step 2414, it may be determined if the user accepted the prompt. If the prompt was accepted, the trade may be posted as fully assigned (step 2416). If not, the flow may continue to exit point V.

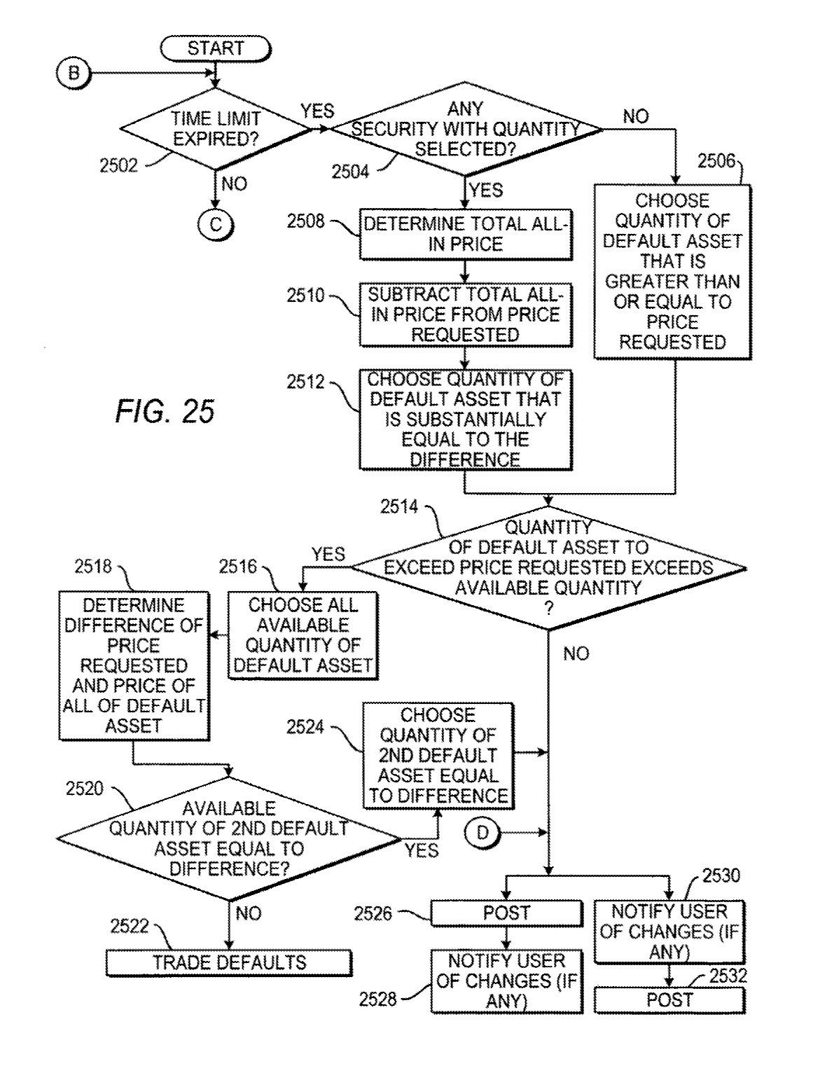

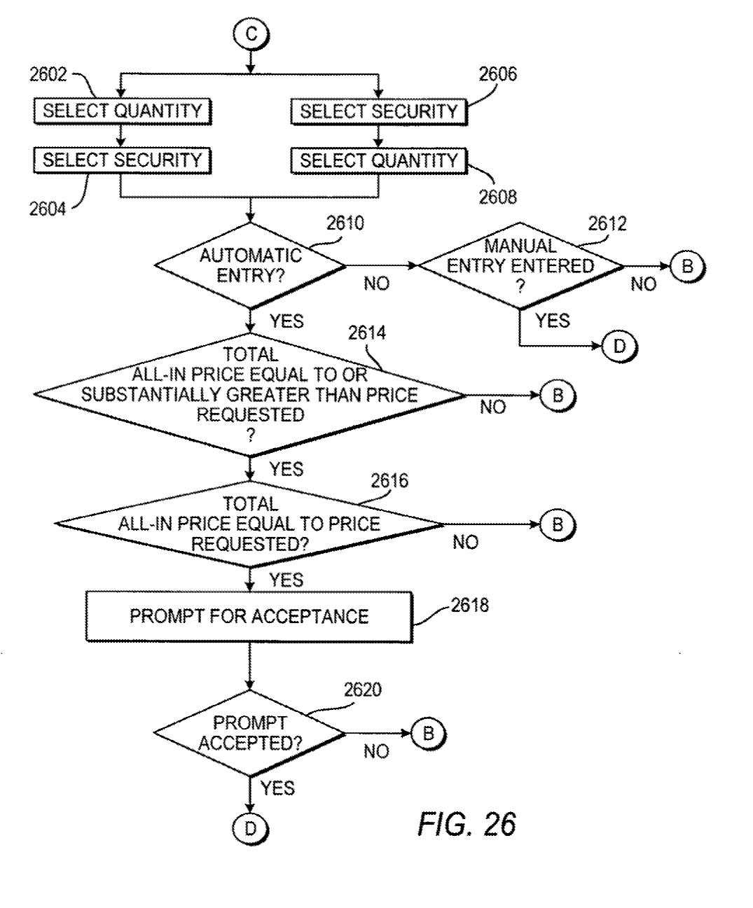

FIGS. 25 and 26 illustrate a flow chart of illustrative steps that may be involved in automatically assigning assets and assigning default assets when the time limit to assign assets for a trade has expired or is close to expiring. As shown in FIG. 25, it may be determined if the time limit to assign assets for a trade has expired (step 2502). If the time limit has not expired, the flow may continue to exit point C (FIG. 26).

From entry point C, shown in FIG. 26, the user may select an asset and a quantity (steps 2602-2608). At step 2610, it may be determined if automatic entry was selected. If automatic entry was selected, the flow may continue at step 2614. If automatic entry were not selected, it may be determined if a manual entry was selected (step 2612). If a manual entry was not selected the flow may continue to exit point B. If a manual entry was selected, the flow may continue at exit point D (FIG. 25).

At step 2614, it may be determined if the total all-in price is substantially greater than or equal to the price requested. If the determination is no, the flow may continue to exit point B (FIG. 25). If the determination is yes, the flow may continue to step 2616. At step 2616, it may be determined that if the total all-in price is substantially equal to the price requested. If the total all-in price is not substantially equal to the price requested, the flow may continue to exit point B. If the total all-in price is substantially equal to the price requested, the flow may continue to step 2618. At step 2618, the user may be prompted to accept the automatic entry. It may be determined if the prompt was accepted at step 2620. If the prompt was accepted, the flow may continue at entry point D (FIG. 25). If the prompt was not accepted, the flow may continue at entry point B (FIG. 25).

Returning to FIG. 25, entry point B flows to step 2502. As stated previously, if it was determined that the time limit to assign assets for a trade has not expired at step 2502, the flow may continue to exit point C (FIG. 26). If the time limit has expired, the flow may continue to step 2504.

At step 2504, it may be determined if any asset with a quantity has been selected (e.g., selected but not assigned). If the determination is no, a quantity of a default asset that will make the total all-in price greater than or equal to the price requested may be chosen at step 2506. If, at step 2504, the determination was that an asset with a quantity has been selected, the total all-in price may be determined at step 2508. The total all-in price may be subtracted from the price requested at step 2510. At step 2512, a quantity of a default asset may be chosen such that the all-in price of that asset is substantially equal to the difference of the subtraction in step 2510.

From steps 2512 and 2506, the flow may continue to step 2514 at which point it may be determined if the quantity of the default asset to exceed the price requested exceeds the available quantity of that default asset. If the determination at step 2514 is yes, all of the available quantity of that default asset may be assigned at step 2516. At step 2518, the difference of the price requested and the total all-in price of the default asset may be determined. At step 2520, it may be determined if there is an available quantity of a second default asset that may be assigned to equal the difference determined in step 2520. If there is not enough available quantity of a second default asset, all of the available quantity of the second default asset may be assigned, the difference of the price requested and the total all-in price of the assigned default assets may be determined, and a quantity of a third default asset may be assigned to meet the difference. This is not shown.

If at step 2520, it was determined that there is not an available quantity of a second default asset equal to the difference determined in step 2518, the flow may continue to step 2522. At step 2522, the trade may default. If at step 2520, the system determined that there is an available quantity, the flow may continue to step 2524. At step 2524, the quantity of the second default asset equal to the difference may be assigned.

The steps after step 2524 are preferably the same as the steps taken if the determination at step 2514 is no. These steps are that the trade may be posted and then the user may be notified of changes to the assignment of assets (if any) or vice versa (steps 2526, 2528, 2530, and 2532).

Thus, systems and methods for electronic asset assignment and tracking are provided. One skilled in the art will appreciate that the invention can be practiced by other than the described embodiments, which are presented for purposes of illustration and not of limitation, and the invention is limited only by the claims which follow.

What is claimed is:

1. A method comprising:
receiving a selection of a pending offer to purchase at least one asset, the pending offer including a plurality of terms from a first counterparty comprising a price requested, a time limit for assigning at least one asset to a pending order, and at least one criterion for qualifying the at least one asset;
automatically assigning to the offer an available quantity of a first default asset of a second counterparty that satisfies the at least one criterion, the first default asset assigned automatically at least when a total price of assets assigned to the offer at the time limit does not meet or exceed the price requested.

2. The method of claim 1, comprising automatically assigning to the offer an available quantity of a second default asset of the second counterparty that satisfies the at least one criterion when the total price of assets assigned to the offer does not meet or exceed the price requested.

3. The method of claim 2, wherein the at least one criterion comprises a criterion for qualifying at least one security and wherein the first and the second default assets assigned to the offer comprise different securities of the second counterparty that satisfy the at least one criterion.

4. The method of claim 2, wherein the at least one criterion qualifies a plurality of bonds based on maturity and wherein the first and second default assets are each at least one bond, the first default asset comprising a bond having a maturity different than a bond of another default asset.

5. The method of claim 1, comprising
displaying an interface screen comprising a listing of at least one asset of the second counterparty that satisfies the at least one criterion, a quantity of the at least one asset available to for offer, and at least one field for specifying a quantity of the at least one asset to be assigned to the offer; and
receiving a selection assigning to the pending offer at least one asset that satisfies the at least one criterion and a quantity of the selected at least one asset.

6. The method of claim 1, wherein the at least one criterion qualifies a specific asset and wherein the first default asset is assigned automatically in response to the second counterparty lifting the offer.

7. The method of claim 1, wherein the at least one criterion qualifies a plurality of different securities.

8. The method of claim 1, wherein the at least one criterion qualifies a plurality of bonds based on maturity and wherein the first default asset comprises at least one bond having a maturity that satisfies the at least one criterion.
